(19) United States
(12) Patent Application Publication
(10) Pub. No.: US 2025/0045761 A1
(43) Pub. Date: Feb. 6, 2025

(54) METHODS, SYSTEMS, AND MEDIA FOR SCREENING USERS OF A VIRTUAL ENVIRONMENT

(71) Applicant: Integral Ad Science, Inc., New York, NY (US)

(72) Inventors: Tanishq Nimale, Pune (IN); Prashant Jawale, Pune (IN); Abhishek Vyas, Pune (IN); Adarsh Singh, Pune (IN); Vinay Gaykar, Pune (IN)

(21) Appl. No.: 18/606,146

(22) Filed: Mar. 15, 2024

Related U.S. Application Data
(60) Provisional application No. 63/452,254, filed on Mar. 15, 2023.

(51) Int. Cl. G06Q 20/40; G06F 21/55; G06T 19/00

(52) U.S. Cl. CPC G06Q 20/4016; G06F 21/554; G06T 19/003; G06T 2200/24; G06T 2219/024

(57) ABSTRACT

Methods, systems, and media for screening users of a virtual environment are provided. In some embodiments, the method comprises: determining one or more first representative values of one or more first metrics for a first user, wherein the one or more first metrics are associated with one or more content items presented within a virtual environment and wherein the one or more first metrics includes: (i) angles between orientation vectors of one or more content items and view directions of one or more virtual cameras in the virtual environment, wherein the one or more virtual cameras are controlled by the first user; (ii) on-screen real estates of the one or more content items based on distances between the one or more content items and the one or more virtual cameras controlled by the first user; (iii) view duration in which a content item of the one or more content items was at least partially presented for the first user on a rendered screen of the virtual environment during a predetermined amount of time; and (iv) a comparison between the view duration and a duration in which the one or more virtual cameras were controlled by the first user during the predetermined amount of time; in response to determining the one or more first representative values of the one or more first metrics, comparing the one or more first representative values to one or more corresponding reference values, wherein comparing the one or more first representative values to the one or more corresponding reference values comprises determining a fraud score based on the one or more first representative values and the one or more corresponding reference values; in response to determining the fraud score, determining that the fraud score is within a first predetermined range of values; and, in response to determining that the fraud score is within the first predetermined range of values, determining that the first user in the virtual environment is a human user.

### CROSS-REFERENCE TO RELATED APPLICATIONS

This application claims the benefit of United States Provisional Patent Application No. 63/452,254, filed Mar. 15, 2023, which is hereby incorporated by reference herein in its entirety.

### TECHNICAL FIELD

The disclosed subject matter relates to methods, systems, and media for screening users of a virtual environment.

### BACKGROUND

Many people use virtual environments for video gaming, social networking, work activities, and increasingly more activities. Such virtual environments can be highly dynamic, and can have robust graphics processing capabilities that produce realistic lighting, shading, and particle systems, such as snow, leaves, smoke, etc. While these effects can provide a rich user experience, they can also affect digital advertising content that has been placed in the virtual environment. It can be difficult for advertisers to track viewability for their advertisements due to the many variables present in the virtual environment.

Additionally, within some virtual environments, one may wish to determine if a user controlling a virtual camera within a virtual environment is a human user. If the user is deemed to not to be a human user, the user may be, for example, be a bot programmed to perform any number of malicious activities. For example, a malicious bot can be programmed to view advertising content items presented within the virtual environment to increase the number of views associated with the advertising content items. In another example, a malicious bot can be programmed to imitate a legitimate human user of a virtual environment selecting and/or viewing advertising content items such that a payment is made for the engagement without having an actual interest in the advertising content items and/or with the objective of depleting advertising budgets. As such, the advertising entity may wish to exclude such views or interactions from being counted and/or may wish to prevent such nonhuman users from accessing the virtual environment.

Accordingly, it is desirable to provide new mechanisms for screening users of a virtual environment.

### SUMMARY

Methods, systems, and media for screening users of a virtual environment are provided.

In accordance with some embodiments of the disclosed subject matter, a method for screening users in virtual environments is provided, the method comprising: determining one or more first representative values of one or more first metrics for a first user, wherein the one or more first metrics are associated with one or more content items presented within a virtual environment and wherein the one or more first metrics includes: (i) angles between orientation vectors of one or more content items and view directions of one or more virtual cameras in the virtual environment, wherein the one or more virtual cameras are controlled by the first user; (ii) on-screen real estates of the one or more content items based on distances between the one or more content items and the one or more virtual cameras controlled by the first user; (iii) view duration in which a content item of the one or more content items was at least partially presented for the first user on a rendered screen of the virtual environment during a predetermined amount of time; and (iv) a comparison between the view duration and a duration in which the one or more virtual cameras were controlled by the first user during the predetermined amount of time; in response to determining the one or more first representative values of the one or more first metrics, comparing the one or more first representative values to one or more corresponding reference values, wherein comparing the one or more first representative values to the one or more corresponding reference values comprises determining a fraud score based on the one or more first representative values and the one or more corresponding reference values; in response to determining the fraud score, determining that the fraud score is within a first predetermined range of values; and, in response to determining that the fraud score is within the first predetermined range of values, determining that the first user in the virtual environment is a human user.

In some embodiments, the method further comprises, in response to determining that the first user is a human user, storing an association between a first category indicating that the first user is a human user; and storing a number of views associated with the first user.

In some embodiments, the one or more corresponding reference values are based on second representative values of one or more second metrics, wherein the one or more second metrics include: (i) second angles between the orientation vectors of the one or more content items and second view directions of one or more second virtual cameras in the virtual environment, the one or more second virtual cameras controlled by a plurality of users; (ii) second on-screen real estates of the one or more content items based on distances between the one or more content items and the one or more second virtual cameras controlled by the plurality of users; (iii) a second view duration in which the content item of the one or more content items was at least partially presented for the plurality of users on the rendered screen of the virtual environment during a predetermined amount of time; and (iv) a second comparison between the second view duration and a second duration in which the one or more second virtual cameras were controlled by the plurality of users during the predetermined amount of time.

In some embodiments, determining of the one or more first representative values of the one or more first metrics for the first user is performed at a first time, and the method further comprises: determining one or more third representative values of the one or more first metrics for the first user at a second time; in response to determining the one or more third representative values of the one or more first metrics, comparing the one or more third representative values to one or more corresponding second reference values, wherein comparing the one or more third representative values to the one or more corresponding second reference values comprises determining a second fraud score based on the one or more third representative values and the one or more corresponding second reference values; in response to determining the second fraud score, determining that the second fraud score is within a second predetermined range of values; in response to determining that the second fraud score is within the second predetermined range of values, determining that the first user is a nonhuman user; and, in response to determining that the first user is the nonhuman user, inhibiting the first user from accessing the virtual environment by removing one or more accounts associated with the first user.

In some embodiments, the one or more first representative values of the angles includes a mean value of the angles between the orientation vectors of the one or more content items and the view directions of the one or more virtual cameras in the virtual environment, and the one or more first representative values of the on-screen real estates includes a mean value of the on-screen real estates of the one or more content items based on the distances between the one or more content items and the one or more virtual cameras controlled by the first user.

In some embodiments, the one or more first representative values of the angles includes a median value of the angles between the orientation vectors of the one or more content items and the view directions of the one or more virtual cameras in the virtual environment, and the one or more first representative values of the on-screen real estates includes a median value of the on-screen real estates of the one or more content items based on the distances between the one or more content items and the one or more virtual cameras controlled by the first user.

In some embodiments, the one or more first representative values of the angles includes a mode value of the angles between the orientation vectors of the one or more content items and the view directions of the one or more virtual cameras in the virtual environment, and the one or more first representative values of the on-screen real estates includes a mode value of the on-screen real estates of the one or more content items based on the distances between the one or more content items and the one or more virtual cameras controlled by the first user.

In accordance with some embodiments of the disclosed subject matter, a system for screening users in virtual environments is provided, the system comprising a hardware processor that is configured to: determine one or more first representative values of one or more first metrics for a first user, wherein the one or more first metrics are associated with one or more content items presented within a virtual environment and wherein the one or more first metrics includes: (i) angles between orientation vectors of one or more content items and view directions of one or more virtual cameras in the virtual environment, wherein the one or more virtual cameras are controlled by the first user; (ii) on-screen real estates of the one or more content items based on distances between the one or more content items and the one or more virtual cameras controlled by the first user; (iii) view duration in which a content item of the one or more content items was at least partially presented for the first user on a rendered screen of the virtual environment during a predetermined amount of time; and (iv) a comparison between the view duration and a duration in which the one or more virtual cameras were controlled by the first user during the predetermined amount of time; in response to determining the one or more first representative values of the one or more first metrics, compare the one or more first representative values to one or more corresponding reference values, wherein comparing the one or more first representative values to the one or more corresponding reference values comprises determining a fraud score based on the one or more first representative values and the one or more corresponding reference values; in response to determining the fraud score, determine that the fraud score is within a first predetermined range of values; and, in response to determining that the fraud score is within the first predetermined range of values, determine that the first user in the virtual environment is a human user.

In accordance with some embodiments of the disclosed subject matter, a computer-readable medium containing computer executable instructions that, when executed by a processor, cause the processor to perform a method for screening users in virtual environments is provided, the method comprising: determining one or more first representative values of one or more first metrics for a first user, wherein the one or more first metrics are associated with one or more content items presented within a virtual environment and wherein the one or more first metrics includes: (i) angles between orientation vectors of one or more content items and view directions of one or more virtual cameras in the virtual environment, wherein the one or more virtual cameras are controlled by the first user; (ii) on-screen real estates of the one or more content items based on distances between the one or more content items and the one or more virtual cameras controlled by the first user; (iii) view duration in which a content item of the one or more content items was at least partially presented for the first user on a rendered screen of the virtual environment during a predetermined amount of time; and (iv) a comparison between the view duration and a duration in which the one or more virtual cameras were controlled by the first user during the predetermined amount of time; in response to determining the one or more first representative values of the one or more first metrics, comparing the one or more first representative values to one or more corresponding reference values, wherein comparing the one or more first representative values to the one or more corresponding reference values comprises determining a fraud score based on the one or more first representative values and the one or more corresponding reference values; in response to determining the fraud score, determining that the fraud score is within a first predetermined range of values; and, in response to determining that the fraud score is within the first predetermined range of values, determining that the first user in the virtual environment is a human user.

In accordance with some embodiments of the disclosed subject matter, a system for screening users in virtual environments is provided, the system comprising: means for determining one or more first representative values of one or more first metrics for a first user, wherein the one or more first metrics are associated with one or more content items presented within a virtual environment and wherein the one or more first metrics includes: (i) angles between orientation vectors of one or more content items and view directions of one or more virtual cameras in the virtual environment, wherein the one or more virtual cameras are controlled by the first user; (ii) on-screen real estates of the one or more content items based on distances between the one or more content items and the one or more virtual cameras controlled by the first user; (iii) view duration in which a content item of the one or more content items was at least partially presented for the first user on a rendered screen of the virtual environment during a predetermined amount of time; and (iv) a comparison between the view duration and a duration in which the one or more virtual cameras were controlled by the first user during the predetermined amount of time; means for comparing the one or more first representative values to one or more corresponding reference values in response to determining the one or more first representative values of the one or more first metrics, wherein comparing the one or more first representative values to the one or more corresponding reference values comprises means for determining a fraud score based on the one or more first representative values and the one or more corresponding reference values; means for determining that the fraud score is within a first predetermined range of values in response to determining the fraud score; and means for determining that the first user in the virtual environment is a human user in response to determining that the fraud score is within the first predetermined range of values.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1A is an example flow diagram of a process for screening users of a virtual environment in accordance with some embodiments of the disclosed subject matter.

FIG. 1B is an example flow diagram of a process for determining one or more first values of one or more first metrics in accordance with some embodiments of the disclosed subject matter.

FIG. 2A is an example illustration of a first content item that is determined to be within a view frustum of a virtual environment in accordance with some embodiments of the disclosed subject matter.

FIG. 2B is an example illustration of a second content item that is determined to not be within a view frustum of a virtual environment in accordance with some embodiments of the disclosed subject matter.

FIG. 2C is an example illustration of a content item that is determined to be within a viewport of a virtual environment in accordance with some embodiments of the disclosed subject matter.

FIG. 3 is an example illustration of two objects having relative rotations in accordance with some embodiments of the disclosed subject matter.

FIG. 4 is an example illustration of relative scale for an advertisement on a curved surface in a virtual environment in accordance with some embodiments of the disclosed subject matter.

FIG. 5 is an example illustration of ray casting on a curved advertisement in accordance with some embodiments of the disclosed subject matter.

FIG. 6 is an example illustration for selecting a first plurality of pixels of a content item in accordance with some embodiments of the disclosed subject matter.

FIG. 7 is an example illustration for comparing a second plurality of pixels of a first image of a rendered screen of a virtual environment with a first plurality of pixels of the content item in accordance with some embodiments of the disclosed subject matter.

FIG. 8 is an example illustration for comparing a second plurality of pixels of a second image of a second rendered screen of a virtual environment with a first plurality of pixels of the content item in accordance with some embodiments of the disclosed subject matter.

FIG. 9 is an example block diagram of a system that can be used to implement mechanisms described herein in accordance with some implementations of the disclosed subject matter.

FIG. 10 is an example block diagram of hardware that can be used in a server and/or a user device of FIG. 9 in accordance with some implementations of the disclosed subject matter.

### DETAILED DESCRIPTION

In accordance with various embodiments of the disclosed subject matter, mechanisms (which can include methods, systems, and media) for screening users of a virtual environment are provided.

In some embodiments, the content item can be an advertising content item. In some embodiments, the content item can include a media content item such as an image, a video, a frame of a video, a sequence of frames of a video, etc., or any suitable combination thereof. In some embodiments, the content item can include text, graphics, logos, etc. that can be used to advertise a particular company, a brand, a product, a service, etc. In some embodiments, the content item can be positioned within the virtual environment. In some embodiments, the content item can be included in, or attached to a surface of any other object within the virtual environment, such as a content item object. In some embodiments, the content item can be stored in any suitable memory and/or storage and in any suitable media file format, such as an image file format, video file format, etc. The content item can be stored in any suitable device, such as a user device, a server, or any suitable combination thereof.

In some embodiments, the virtual environment can be any virtual environment that can be generated by any suitable device, such as a user device, a server, or any suitable combination thereof. In some embodiments, the virtual environment can be any virtual reality environment, any augmented reality environment, any video game environment, or any other computer-generated environment that can be interacted with by a user. In some embodiments, the virtual environment can have two or more spatial dimensions. Accordingly, positions within the virtual environment can have two or more dimensions. In some embodiments, the virtual environment can be stored in any suitable memory and/or storage capable of storing a virtual environment having two or more spatial dimensions. In some embodiments, the virtual environment can be a two-dimensional, two-and-a-half-dimensional, or three-dimensional virtual environment.

In some embodiments, a view frustum within the virtual environment can be generated, where the view frustum includes at least a region of the virtual environment that can be presented to a user. In some embodiments, a viewport of the virtual environment can be generated, where the viewport can include a projection of the region within the view frustum onto any surface. In some embodiments, the viewport can include a projection of the region within the view frustum onto any surface perpendicular to a viewing direction of a virtual camera in the virtual environment.

In some embodiments, the rendered screen of the virtual environment can be generated, where the rendered screen includes at least a portion of the viewport. In some embodiments, the rendered screen of the virtual environment and the viewport can be two-dimensional. Accordingly, positions in the rendered screen or positions in the viewport can be two-dimensional. In some embodiments, the rendered screen can include at least a portion of the content item if the content item is positioned in the view frustum. In some embodiments, the rendered screen can include any user interface elements. For example, in some embodiments, the user interface elements can include any elements, such as menus (e.g., main menus, pause menus, etc.), heads-up display (HUD) elements (e.g., health meters, experience meters, speed meters, etc.), timers, maps, compasses, cursors, reticles, crosshairs, inventory elements, etc., any text associated therewith, or any suitable combination thereof. In some embodiments, the user interface elements can be included in the rendered screen of the virtual environment whether or not the user interface elements are included in the view frustum of the virtual environment. In some embodiments, the rendered screen can be presented at any suitable device, such as a user device, a server, or any suitable combination thereof.

In some embodiments, the rendered screen of the virtual environment can include one or more visual elements positioned within the virtual environment. In some embodiments, the one or more visual elements can collide with casted rays. A casted ray is a virtual ray that can be generated within the virtual environment to collide with objects that are programmed to collide with casted rays, and that are positioned within a path of the casted ray. A collision between a casted ray and any object (including any visual element) within the virtual environment can indicate the position of the object along the path of the casted ray. In some embodiments, the one or more visual elements can obstruct the content item from the perspective of a virtual camera within the virtual environment. Accordingly, the mechanisms described herein can include determining whether a content item being presented within the virtual environment is being obstructed by the one or more visual elements by casting rays toward the content item. In some embodiments, the casted rays can be directed from the position of the virtual camera toward the content item.

In some embodiments, the rendered screen of the virtual environment can include visual elements. In some embodiments, the one or more visual elements can include any user interface elements. In some embodiments, the one or more visual elements can at least partially obstruct the content item when the one or more visual elements are presented on the rendered screen of the virtual environment. For example, in some embodiments, the user interface elements can include any elements, such as menus (e.g., main menus, pause menus, etc.), heads-up display (HUD) elements (e.g., health meters, experience meters, speed meters, etc.), timers, maps, compasses, cursors, reticles, crosshairs, inventory elements, etc., any text associated therewith, or any suitable combination thereof. In some embodiments, the user interface elements can be included in the rendered screen of the virtual environment whether or not the user interface elements are included in the view frustum of the virtual environment. In some embodiments, the rendered screen can be presented at any suitable device, such as a user device, a server, or any suitable combination thereof.

In some embodiments, at least a portion of the users in the virtual environment can be human users, and at least a portion of the users in the virtual environment can be nonhuman users (e.g., a bot or other application that simulates human user activity). In some embodiments, the nonhuman users can include one or more bots programmed to control one or more virtual cameras in the virtual environment. In some embodiments, the one or more bots can include any computer program programmed to control one or more virtual cameras in the virtual environment. Mechanisms according to some embodiments of the disclosed subject matter can include screening users to determine whether users in the virtual environment are human users or nonhuman users.

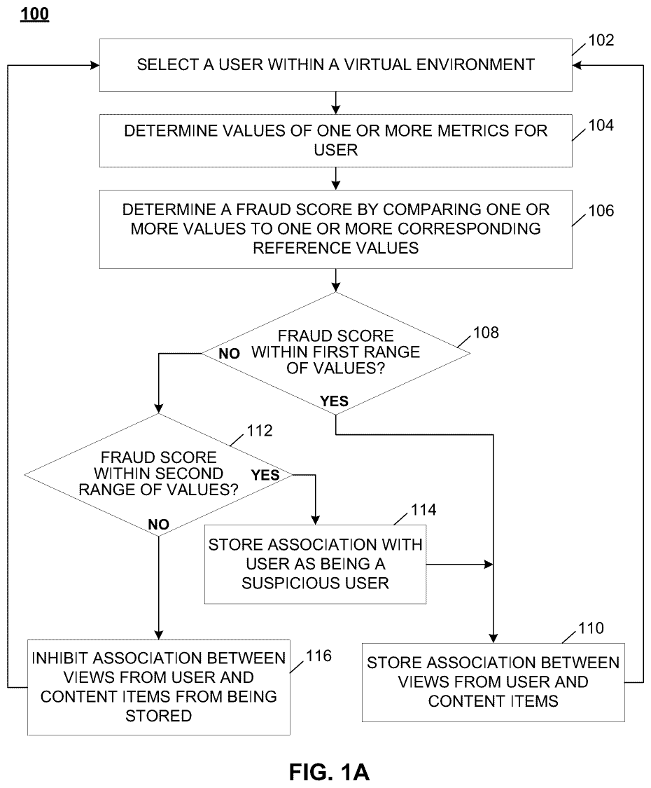

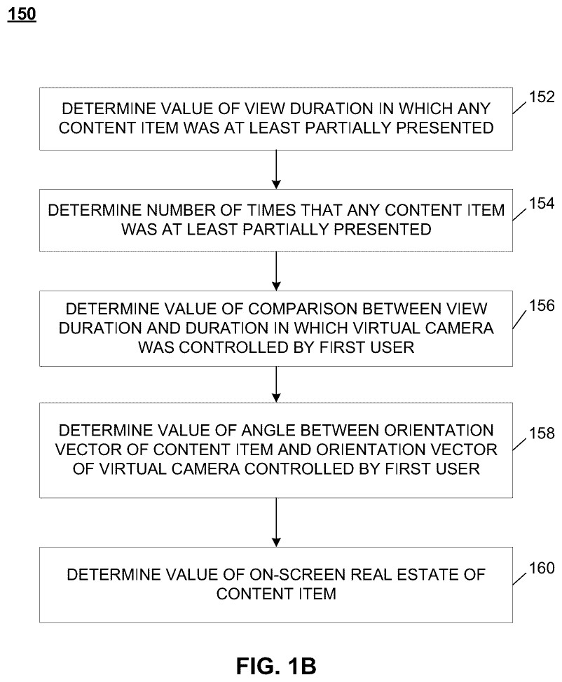

These and other features for screening users in a virtual environment are further described in connection with FIGS. 1A-10.

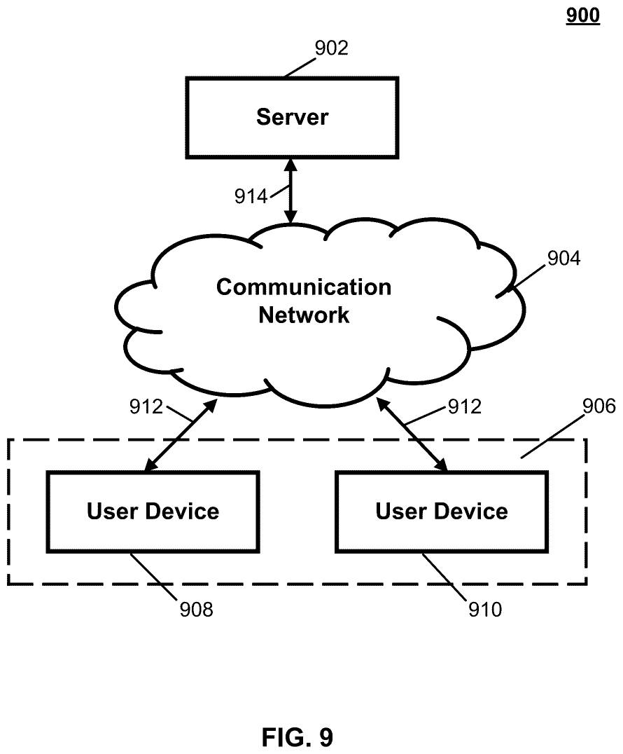

FIG. 1A shows an illustrative example of a process 100 for screening users of a virtual environment in accordance with some embodiments of the disclosed subject matter. In some embodiments, process 100 can be executed on any suitable device, such as a server (e.g., server 902 in FIG. 9), one or more user devices (e.g., user device 906 in FIG. 9), or any suitable combination thereof.

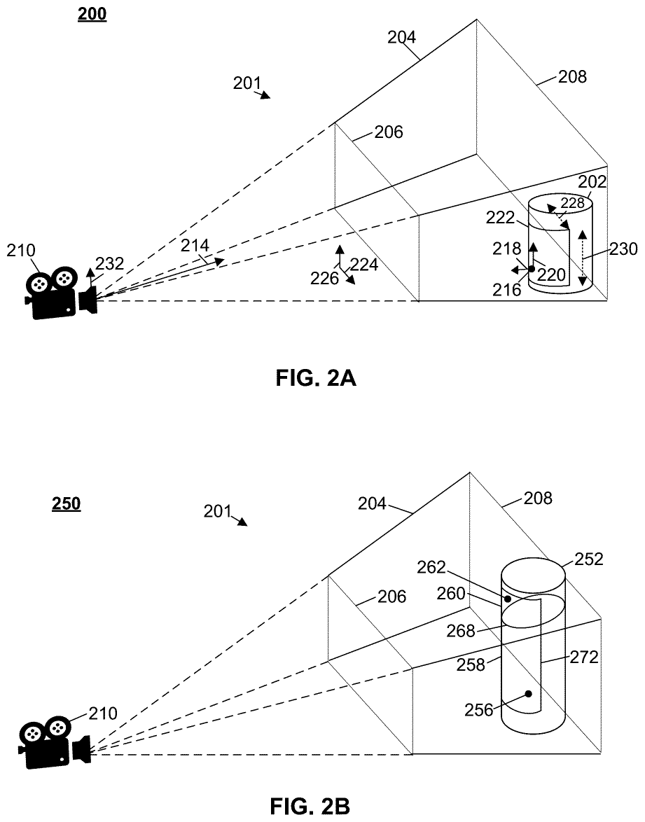

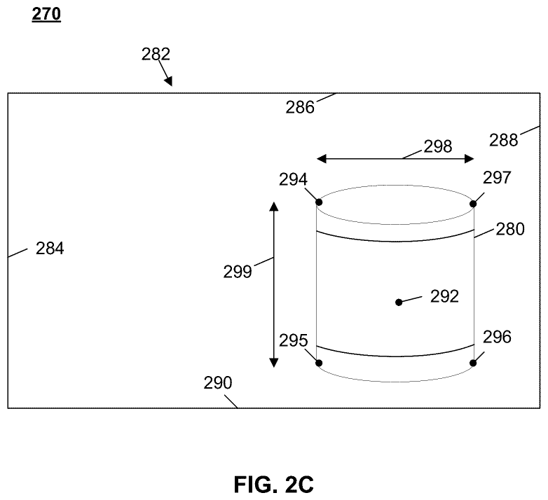

In some embodiments, at block 102, process 100 can select a first user of the virtual environment. In some embodiments, the first user can be any user that controls one or more virtual cameras (e.g., virtual camera 210 in FIGS. 2A and 2B) in the virtual environment. In some embodiments, the first user can control a position and/or an orientation of the one or more virtual cameras within the virtual environment. In some embodiments, the first user can be randomly selected. In some embodiments, any number of users of the virtual environment can be selected at any time. In some embodiments, the first user can be selected based on the distance between a virtual camera controlled by the first user and any suitable object in the virtual environment, such as a content item (e.g., content item 222 in FIG. 2A, content item 272 in FIG. 2B, content item 280 in FIG. 2C, etc.). In some embodiments, the content item can be an advertising content item.

In some embodiments, at block 104, process 100 can determine one or more first values of one or more first metrics for the first user. In some embodiments, the first user selected at block 102 can be selected based on the one or more first values. In some embodiments, process 100 can execute any suitable sub-processes to collect measurements relating to any suitable metric (e.g., view duration, orientation, etc.) as described more hereafter in connection with FIG. 1B. Continuing this example, in some embodiments, process 100 can determine representative values based on the values of the one or more first metrics.

In some embodiments, the first values determined at block 104 can include representative values of the one or more first metrics. In some embodiments, a representative value can be any value that is representative of a plurality of values of a metric. In some embodiments, a representative value can be an average value of a metric. In some embodiments, any average value can be based on a number of times that any content item was at least partially presented on any rendered screen, a number of content items at least partially presented on any rendered screen, a predetermined amount of time during which any content item was at least partially presented on any rendered screen, or any combination thereof. In some embodiments, any average value can include a mean value, a median value, and/or a mode value. In some embodiments, any average can include a mean value, median value, and/or mode value for the first user during a predetermined amount of time. In some embodiments, any outliers can be removed from a plurality of values before determining a representative value of the plurality of values. In some embodiments, the one or more first values of the one or more first metrics can be determined by any suitable process, as described more hereafter with reference to FIG. 1B.

In some embodiments, the first values of the one or more metrics can include any suitable values in any suitable ranges. In some embodiments, any of the first values of the one or more metrics can be determined in any suitable units. In some embodiments, any of the first values of the one or more metrics can be unitless. In some embodiments, the first values of the one or more first metrics can be normalized values. In some embodiments, the one or more first metrics can include any number of metrics that can indicate a measurement of view quality of a content item presented in the virtual environment.

FIG. 1B shows an example flow diagram of a process 150 for determining one or more first values of one or more first metrics, according to some embodiments of the disclosed subject matter. In some embodiments, the one or more first metrics can include (i) a view duration in which any content item was at least partially presented on any rendered screen, (ii) a number of times that any content item was at least partially presented on a rendered screen of the virtual environment, (iii) a value of a comparison between the view duration and a duration in which a virtual camera was controlled by the first user, (iv) a value of an angle between an orientation vector of a content item and an orientation vector of the virtual camera, (v) a value of an on-screen real estate of a content item, any other suitable metric(s), or any suitable combination thereof.

In some embodiments, at block 152, process 150 can determine a value of a view duration in which any content item was at least partially presented on any rendered screen of the virtual environment for the first user during a predetermined amount of time. In some embodiments, process 150 can determine a value of view durations (e.g., a representative value) in which any content item was at least partially presented on any rendered screen of the virtual environment for the first user. In some embodiments, a higher view duration can indicate that a content item was presented on a rendered screen to a user for a longer amount of time.

In some embodiments, a view duration determined at block 152 can be a cumulative view duration during the predetermined amount of time for the first user. In some embodiments, the view duration can be a single cumulative view duration in which any content item was at least partially presented on any rendered screen during the predetermined amount of time for the first user. In some embodiments, any duration in which a content item is at least partially presented on any rendered screen for the first user can contribute to the view duration associated with the first user. In some embodiments, a value of a view duration can be represented in any suitable units of time (e.g., nanoseconds, milliseconds, seconds, hours, etc.).

As part of the determination of the view duration, at block 152, any suitable process can be performed to determine if a content item is at least partially presented on a rendered screen of the virtual environment. In some embodiments, process 150 can, at block 152, determine if a content item is at least partially presented on a rendered screen by determining if the content item is in a view frustum (e.g., view frustum 201 in FIGS. 2A and 2B) of the virtual environment as described more hereafter with reference to FIGS. 2A and 2B. In some embodiments, process 150 can, at block 152, determine if a content item is at least partially presented on a rendered screen by determining if the content item is positioned within boundaries of a viewport (e.g., viewport 282 in FIG. 2C) as described further hereinbelow in connection with FIG. 2C. However, in some embodiments, even if a content item is positioned in a view frustum, or even if the content item is positioned within boundaries of a viewport, the content item can still be obstructed by an object positioned between the content item and a virtual camera.

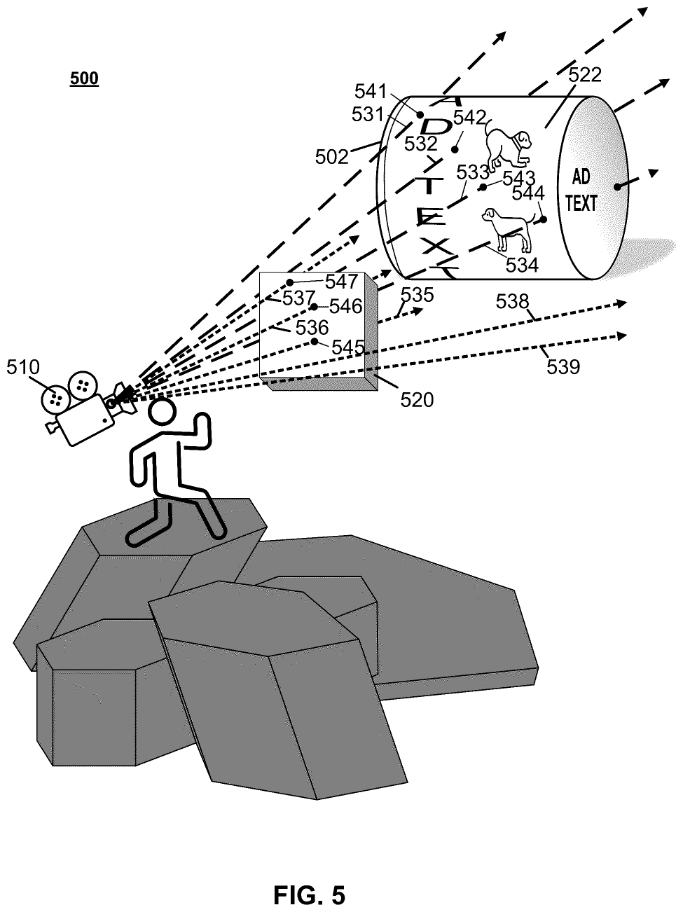

Accordingly, in some embodiments, process 150 can, at block 152, determine if a content item is at least partially presented on a rendered screen by determining if an object is positioned between the content item and the virtual camera. If an object is positioned between the virtual camera and at least a portion of the content item, the portion of the content item may not be presented on a rendered screen of the virtual environment. If no object is positioned between the virtual camera and a portion of the content item, at least the portion of the content item can be presented on a rendered screen of the virtual environment. In some embodiments, process 150 can cast virtual rays (e.g., virtual rays 531-534 in FIG. 5) from a virtual camera toward the content item to determine if the content item is at least partially presented on a rendered screen of the virtual environment, as described further hereinbelow in connection with FIG. 5.

However, in some embodiments, one or more visual elements (e.g., including user interface elements presented on a rendered screen, some objects) on a rendered screen are not programmed to collide with virtual rays. Accordingly, even if a virtual ray intersects one or more visual elements (e.g., an object positioned between the content item and a virtual camera), the virtual ray may not collide with the one or more visual elements. Additionally, in some embodiments, even if a visual element is not positioned between the content item and the virtual camera, and is for example a user interface element presented on the rendered screen, the user interface element can still prevent at least a portion of the content item from being presented on the rendered screen.

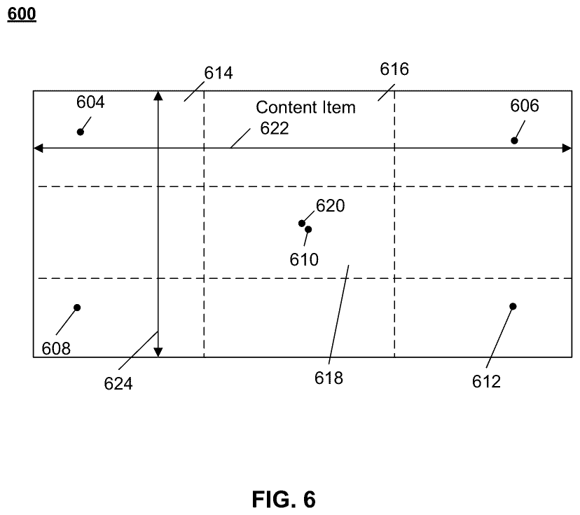

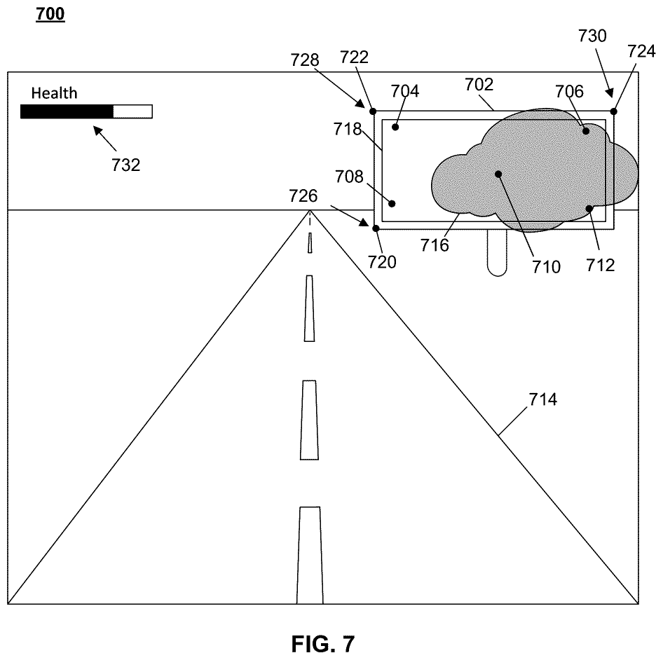

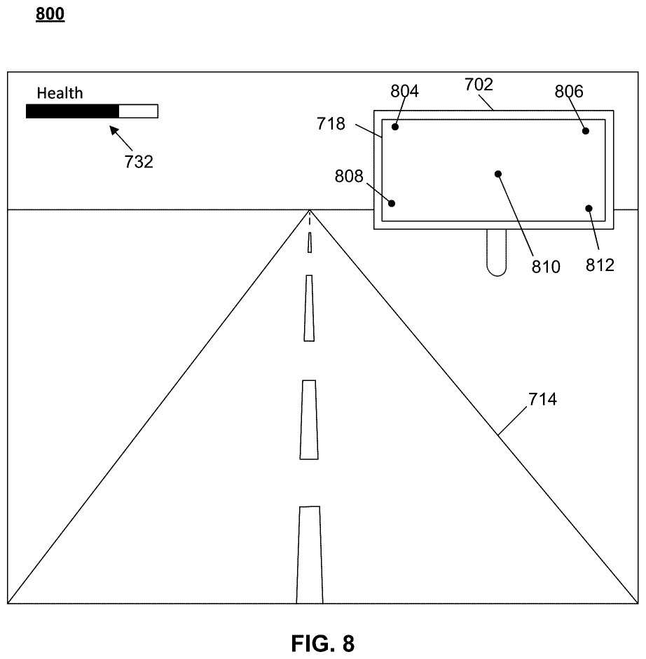

Accordingly, in some embodiments, process 150 can, at block 152, determine if a content item is at least partially presented on a rendered screen without casting any virtual rays toward the content item. In some embodiments, process 150 can, at block 152, determine if a content item is at least partially presented on a rendered screen by comparing a first plurality of pixels of a content item with a second plurality of pixels of an image (e.g., image 700 in FIG. 7, image 800 in FIG. 8, etc.) of a rendered screen of the virtual environment, as described further hereinbelow in connection with FIGS. 6-8.

Referring back to FIG. 1B, in some embodiments, process 150 can, at block 154, determine a number of times that any content item was at least partially presented on a rendered screen of the virtual environment for the first user during a predetermined amount of time.

In some embodiments, at block 156, process 150 can determine a value of a comparison between the view duration determined at block 152 and a duration in which a virtual camera was controlled by the first user during a predetermined amount of time. In some embodiments, process 150 can determine a value (e.g., a representative value) of a comparison between view durations and durations in which a virtual camera was controlled by the first user during a predetermined amount of time. In some embodiments, a comparison can indicate a proportion in which content items were viewed by the first user during the predetermined amount of time. For example, a higher comparison value can indicate that the first user spent more time viewing content items relative to time spent controlling (e.g., moving, rotating) the virtual camera in the virtual environment. As another example, a higher comparison value can indicate that the first user spent more time viewing content items relative to time spent viewing any other objects in the virtual environment.

In some embodiments, process 150 can, at block 156, determine the duration in which a virtual camera was controlled by the first user during a predetermined amount of time. In some embodiments, the duration in which the virtual camera was controlled by the first user can be a cumulative duration. In some embodiments, the duration in which the virtual camera was controlled by the first user can be a single cumulative duration. In some embodiments, the duration in which the first user controlled the virtual camera can be any duration in which the first (e.g., human or nonhuman) user provided input to a computing system to control the virtual camera within the virtual environment. For example, in some embodiments, any duration in which the first user provided input to move and/or rotate the virtual camera can contribute to the duration in which the first user controlled the virtual camera. As another example, if the first user is a human user, the input can be provided by an input device such as a gaming controller, keyboard, mouse, or any combination thereof. As another example, if the first user is a nonhuman user controlled by a computer program, the input can be provided by the computer program. In some embodiments, the first user can maintain a position and/or orientation of the virtual camera. Accordingly, in some embodiments, any duration in which the first user maintained a position and/or orientation of the virtual camera can contribute to the duration in which the first user controlled the virtual camera. In some embodiments, however, the position and orientation of the virtual camera being unchanged for more than a predetermined amount of time can indicate that the first user is no longer controlling the virtual camera. Accordingly, in some embodiments, process 150 can determine when the first user is no longer controlling the virtual camera. In some embodiments, a virtual camera can be controlled by the first user while any content items are being at least partially presented on a rendered screen of the virtual environment.

In some embodiments, the value of the comparison at block 156 can be based on a ratio between a view duration and a duration in which the virtual camera was controlled by the first user. In some embodiments, the value of the comparison can be based on a difference between a view duration and a duration in which the virtual camera was controlled by the first user.

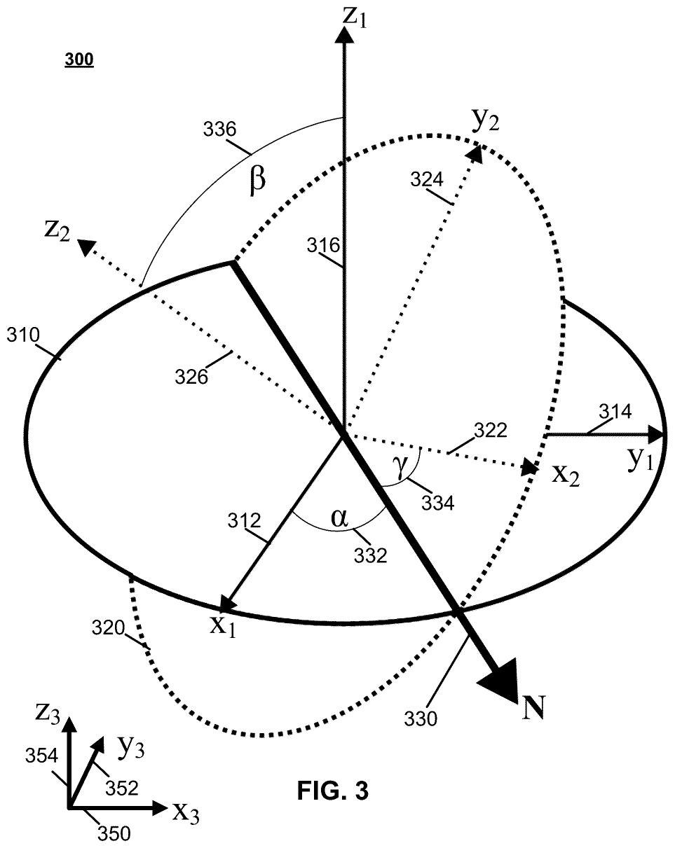

As shown, in some embodiments, at block 158, process 150 can determine a value of an angle between an orientation vector (e.g., vectors 216 and 218 in FIG. 2A, vectors 312, 314, and 316 in FIG. 3, etc.) of a content item and an orientation vector (e.g., vectors 214 and 232 in FIG. 2A, vectors 322, 324, and 326 in FIG. 3, etc.) of the virtual camera controlled by the first user. In some embodiments, process 150 can determine a value (e.g., a representative value) of angles between orientation vectors of one or more content items and orientation vectors of one or more virtual cameras controlled by the first user. In some embodiments, each orientation vector of a content item can be an orientation vector of a content item at least partially presented on a rendered screen of the virtual environment. In some embodiments, if any surface of a content item includes content (e.g., imagery, text, etc.), and the surface of the content item is oriented toward a virtual camera, a human user is better able to read, recognize and/or understand the content (e.g., imagery, text, etc.) in the content item. For example, in some embodiments, if an orientation vector of a content item is perpendicular to the surface of the content item that includes content, and if the orientation vector is oriented toward the virtual camera, the surface of the content item can be considered to be oriented toward the virtual camera. In some embodiments, angles between orientation vectors can be determined by any suitable process, as described further hereinbelow in connection with FIGS. 2A and 3.

As shown, in some embodiments, at block 160, process 150 can determine a value of an on-screen real estate of a content item presented on a rendered screen of a virtual environment. In some embodiments, at block 160, the value of the on-screen real estate can be based on a distance between a content item and a virtual camera controlled by the first user. In some embodiments, process 150 can determine a value (e.g., a representative value) of on-screen real estates of one or more content items based on distances between the one or more content items and one or more virtual cameras controlled by the first user. In some embodiments, each on-screen real estate can be an on-screen real estate of a content item at least partially presented on a rendered screen of the virtual environment. In some embodiments, a content item positioned closer to a virtual camera can have a larger on-screen real estate compared to another object positioned farther away from the virtual camera. In some embodiments, if a content item has a larger on-screen real estate, the content item can appear larger on a rendered screen of the virtual environment. Accordingly, a human user is better able to read, recognize and/or understand any content (e.g., imagery, text, etc.) in the content item.

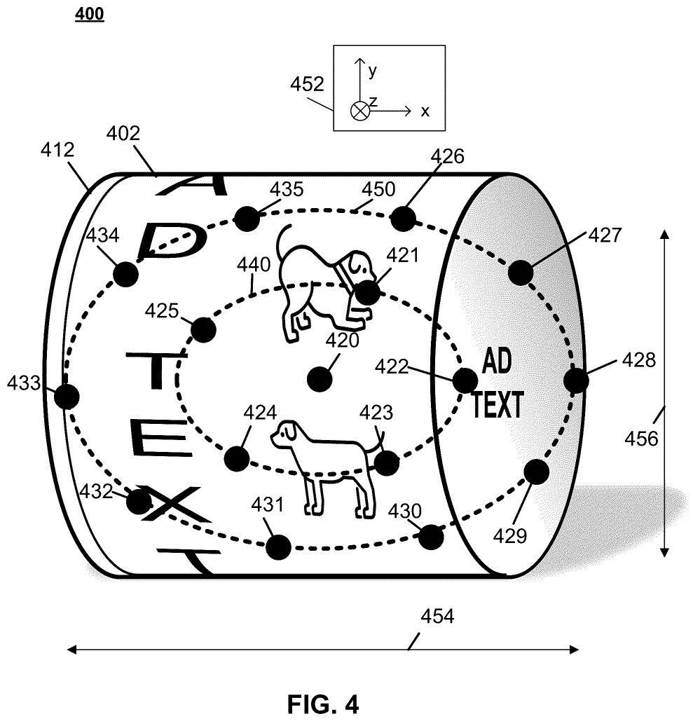

In some embodiments, the on-screen real estate determined at block 160 based on a distance between a content item and a virtual camera can be determined by performing any suitable process, as described further hereinbelow in connection with FIGS. 2A and 4.

In some embodiments, the on-screen real estate determined at block 160 can be based on an amount of one or more rendered screens occupied by any content item during a predetermined amount of time. In some embodiments, the amount can be determined by comparing a first area of a rendered screen occupied by the content item to a second area (e.g., the entire area) of the rendered screen. In some embodiments, the first area of the rendered screen occupied by the content item can be determined by any suitable process, such as described hereinbelow in connection with FIG. 2C.

In some embodiments, any value of the one or more metrics determined at the above-described blocks of process 150 can be determined and updated each time a content item is at least partially presented on a rendered screen of the virtual environment.

Referring back to FIG. 1A, in some embodiments, in response to determining the one or more first values of the one or more first metrics, at block 106, process 100 can compare the one or more first values of the one or more first metrics to one or more corresponding reference values. In some embodiments, the first values of the one or more first metrics being within optimal ranges can indicate that the content items were better presented on a rendered screen of the virtual environment for the first user. Accordingly, an entity, such as an advertising company, may prefer that the first values are within optimal ranges if the first user is a human user. However, the same entity may not be interested in the first values if the first user is a nonhuman user, and optimal values can also indicate that the first user spent more time controlling the virtual camera to ensure that content items were better presented relative to time spent interacting with other objects in the virtual environment, which can indicate that the first user may be a nonhuman user. Accordingly, in some embodiments, the first values can be compared to corresponding reference values to determine if the first user is a human user or a nonhuman user.

In some embodiments, the comparison determined at block 106 can be based on a ratio between the first values of the one or more metrics and the one or more corresponding reference values. In some embodiments, the comparison at block 106 can be based on a difference between the first values of the one or more metrics and the one or more corresponding reference values. In some embodiments, the one or more corresponding reference values can be any suitable values in any suitable ranges. In some embodiments, the reference values can be normalized values. In some embodiments, the reference values can be updated at any time. For example, in some embodiments, the reference values can be updated periodically. In some embodiments, the first values of the one or more first metrics can be normalized based on the one or more corresponding reference values.

In some embodiments, process 100 can, at block 106, determine the one or more corresponding reference values. In some embodiments, the one or more reference values can be based on one or more metrics for a plurality of users. For example, in some embodiments, the one or more reference values can be based on metrics determined using process 150 as described above. That is, in some embodiments, reference values can be based on a representative value (e.g., an average) for each of: (i) value of view durations in which any content item was at least partially presented on any rendered screen of the virtual environment for the plurality of users during a predetermined amount of time (e.g., as described above at block 152); (ii) a number of times that any content item was at least partially presented on any rendered screen of the virtual environment for the plurality of users during a predetermined amount of time (e.g., as described above at block 154); (iii) a value of comparisons between the view durations for the plurality of users and durations in which virtual cameras were controlled by the plurality of users during a predetermined amount of time (e.g., as described above at block 156); (iv) a value of angles between orientation vectors of any content item and view directions of virtual cameras controlled by the plurality of users (e.g., as described above at block 158); (v) a value of on-screen real estates of any content item (e.g., as described above at block 160), or any combination thereof. In some embodiments, the representative value of the on-screen real estates can be based on distances between any content item and the virtual cameras controlled by the plurality of users. As another example, the on-screen real estates can be based on amounts of rendered screens occupied by any content item during a predetermined amount of time.

In some embodiments, any processes (e.g., process 150 as described above) used to determine the first values of the one or more first metrics for the first user can be applied to any user in the plurality of users to determine the corresponding reference values. In some embodiments, the plurality of users can include users that are determined to be human users (e.g., using a comparison such as comparison at block 106).

In some embodiments, an average value determined at block 106 can include a mean, median and/or mode for the plurality of users during the predetermined amount of time. In some embodiments, any average of the plurality of users can be based on a number of times that any content item was at least partially presented on any rendered screen for the plurality of users, a number of content items at least partially presented for the plurality of users, the predetermined amount of time, a number of users in the plurality of users, or any combination thereof. In some embodiments, the comparison between the one or more first values and the one or more corresponding reference values can be based on standard deviations or variances from the representative values of the one or more metrics for the plurality of users.

In some embodiments, the comparison at block 106 between the one or more first values of the one or more first metrics and the one or more corresponding reference values can include any suitable processes. In some embodiments, the comparison can be based on any suitable statistical analyses. For example, in some embodiments, the comparison can be based on a Gaussian distribution analysis of the first values and corresponding reference values.

In some embodiments, the comparison at block 106 can be based on any suitable machine learning model. In some embodiments, suitable machine learning models can include a supervised, semi-supervised, or unsupervised machine learning model. For example, in some embodiments, the comparison can be based on a deep learning model (e.g., using a neural network), a decision tree model, a support vector machine model, a K-nearest neighbor algorithm, a linear discriminant analysis, a regression analysis, a Bayesian network, a Gaussian process, or any combination thereof. In some embodiments, the inputs to the machine learning model can be based at least in part on the first values of the one or more first metrics.

In some embodiments, when a machine learning model is used at block 106, the machine learning model can be trained based on the one or more corresponding reference values. In some embodiments, the machine learning model can be trained based on predetermined classifiers associated with the one or more corresponding reference values, wherein a first classifier indicates that a user is a human user, a second classifier indicates that a user is a suspicious user, and a third classifier indicates that a user is a nonhuman user. In some embodiments, the machine learning model can output a value representing a comparison between the one or more first values of the one or more first metrics and the one or more corresponding reference values.

In some embodiments, the comparison at block 106 between the one or more first values of the one or more first metrics and the one or more corresponding reference values can be based on an artificial neural network of artificial neurons or nodes, wherein the inputs to the neural network are based at least in part on the first values of the one or more first metrics. In some embodiments, the neural network can be trained based on the one or more corresponding reference values. In some embodiments, the neural network can be trained based on predetermined classifiers associated with the one or more reference values. In some embodiments, the neural network can have any suitable number (e.g., zero, one, two, etc.) of hidden layers, and any suitable number of neurons or nodes. In some embodiments, the neural network can output a value representing a comparison between the one or more first values of the one or more first metrics and the one or more corresponding reference values.

In some embodiments, at block 106, the comparison between the one or more first values of the one or more first metrics and the one or more corresponding reference values can include a determination of a fraud score based on the one or more first values and the one or more corresponding reference values. In some embodiments, if a machine learning model is utilized, the fraud score can be based on an output value of the machine learning model. In some embodiments, if a neural network is utilized, the fraud score can be based on an output value of the neural network.

In some embodiments, the fraud score determined at block 106 can be based on weights assigned to the one or more first values of the one or more first metrics. In some embodiments, the weights can have any suitable values in any suitable ranges. In some embodiments, the weights can include positive values, negative values, or any combination thereof. For example, in some embodiments, a higher weight can be assigned to a value of a view duration relative to the weight assigned to an average value of angles between orientation vectors of one or more content items and orientation vectors of one or more virtual cameras controlled by the first user. In some embodiments, the weights can be determined based on the one or more corresponding reference values. In some embodiments, the weights can be determined based on a statistical analysis of the one or more corresponding reference values. In some embodiments, the weights can be updated at any time. For example, in some embodiments, the weights can be updated periodically.

In some embodiments, a higher fraud score determined at block 106 based on the comparison can indicate that the first user is a nonhuman user. In some embodiments, the fraud score can be represented by any suitable number in any suitable range. In some embodiments, the fraud score can indicate the probability that the first user is a nonhuman user. For example, in some embodiments, the fraud score can be in the range between 0.0 and 1.0, where 0.0 indicates a probability of 0.0% that the first user is a nonhuman user, and 1.0 indicates a probability of 100% that the first user is a nonhuman user.

As shown in FIG. 1A, in some embodiments, at block 108, in response to determining the fraud score at block 106, process 100 can determine if the fraud score is within a first predetermined range of values. For example, the first predetermined range of values can be between 0.0 and 0.2, corresponding to a probability between 0.0% and 20% that the user is a nonhuman user. In some embodiments, the first predetermined range of values can be determined by a first threshold. For example, if the first threshold is 0.2, any fraud score equal to or less than 0.2 can result in a determination that the fraud score is within the first predetermined range of values.

In some embodiments, in response to determining that the fraud score is within the first predetermined range of values at block 108, process 100 can determine that the first user is a human user and can continue to block 110. In some embodiments, in response to determining that the first user is a human user, process 100 can store an association between the first user and a suitable category that indicates the first user is a human user. In some embodiments, at block 110, in response to determining that the first user is a human user, process 100 can store an association between a number of views from the first user and any content items presented to the first user. In some embodiments, the number of views can be determined based on the first values of the one or more metrics determined at block 104. For example, in some embodiments, the number of views can be determined by (i) a view duration in which any content item was at least partially presented to the first user; (ii) a number of times that any content item was at least partially presented to the first user; (iii) a value of a comparison between the view duration and a duration in which a virtual camera was controlled by the first user; (iv) an angle between an orientation vector of a content item and view direction of the virtual camera controlled by the first user; (v) an on-screen real estate of a content item, any other suitable metric, or any combination thereof. In some embodiments, process 100 can store an association between the first values of the one or more first metrics and the first user.

As shown, in some embodiments, in response storing the association between the number of views from the first user and any content items presented to the first user at block 110, process 100 can return to block 102 to select any other user.

Alternatively, in some embodiments, in response to determining that the fraud score is not within the first predetermined range of values at block 108, process 100 can continue to block 112. In some embodiments, at block 112, process 100 can determine if the fraud score is within a second predetermined range of values. In some embodiments, the second predetermined range of values and the first predetermined range of values do not overlap. In some embodiments, the second predetermined range of values can be determined by first and second thresholds. For example, if the first threshold is 0.2, and the second threshold is 0.5, any fraud score greater than 0.2, and less than or equal to 0.5 can result in a determination that the fraud score is within the second predetermined range of values.

In some embodiments, in response to determining that the fraud score is within the second predetermined range of values at block 112, process 100 can determine that the first user is a suspicious user. In some embodiments, in response to determining that the first user is a suspicious user, at block 114, process 100 can store an association between the first user and a suitable category that indicates the first user is a suspicious user.

In some embodiments, in response to determining that the first user is a suspicious user, process 100 can continue to block 110, where process 100 can store an association between a number of views from the first user and any content items presented to the first user as discussed above. In some embodiments, process 100 can store an association between the first values of the one or more first metrics and the first user.

In some embodiments, process 100 (or any additional suitable processes) can, at any later time, repeat the comparison between the first values and the corresponding reference values with weights adjusted based on the determination that the first user is a suspicious user. In some embodiments, process 100 can, at any later time, reference the suspicious user association stored at block 114 and can delete or otherwise remove any stored associations between the first values and the first user. In some embodiments, in response to determining that the first user is a suspicious user, process 100 can prevent the first user from accessing the virtual environment. In some embodiments, any accounts associated with the first user can be suspended or deleted.

Alternatively, at block 112, in some embodiments, process 100 can determine that the fraud score is not within the second predetermined range of values, and can continue to block 116. For example, if the first threshold is 0.2 and the second threshold is 0.5, any fraud score greater than 0.5 can result in a determination that the fraud score is not within the second predetermined range of values (and e.g., within a third predetermined range of values). In some embodiments, in response to determining that the fraud score is not within the second predetermined range of values, process 100 can determine that the first user is not a human user. In some embodiments, in response to determining that the first user is not a human user, process 100 can store an association between the first user and a suitable category that indicates the first user is not a human user.

In some embodiments, at block 116, process 100 can stop storing any association between a number of views from the first user and the content items. In some embodiments, at block 116, process 100 can delete any stored associations between the number of views from the first user and the content items. In some embodiments, in response to determining that the first user is not a human user, process 100 can prevent the first user from accessing the virtual environment. In some embodiments, any accounts associated with the first user can be suspended or deleted. As shown, in some embodiments, in response to deleting any stored associations, process 100 can return to block 102 to select any other user.

In some embodiments, process 100 can end at any suitable time. For example, in some embodiments, process 100 can end when there are no active users in the virtual environment and/or within a vicinity of an advertising object. In another example, in some embodiments, process 100 can end after a predetermined number of iterations.

It should be understood that at least some of the above-described blocks of processes 100 and 150 can be executed or performed in any order or sequence not limited to the order and sequence described in connection with FIGS. 1A and 1B. Also, at least some of the above processes 100 and 150 can be executed or performed substantially simultaneously where appropriate or in parallel to reduce latency and processing times. Additionally or alternatively, at least some of the above described subprocesses can be omitted.

FIG. 2A shows an example diagram 200 of a view frustum 201 of a virtual environment in accordance with some embodiments of the disclosed subject matter. In some embodiments, a mechanism according to some embodiments of the disclosed subject matter can determine if a content item 222 is at least partially presented in a rendered screen of the virtual environment by determining if the content item 222 is in the view frustum 201. In some embodiments, if the content item 222 is in the view frustum, the content item 222 can be presented on a rendered screen of the virtual environment.

In some embodiments, the content item 222 can be included in, or attached to, a content item object 202. In some embodiments, the view frustum 201 can include a viewing region in the virtual environment. As shown, the view frustum 201 can be a truncated pyramid, according to some embodiments. However, the view frustum 201 can have any suitable shape such as a pyramid, a cone, any other suitable shape that can be used to define a view region in the virtual environment, any truncated forms thereof, or any combination thereof, according to some embodiments. As shown, the view frustum 201 can have surface(s) 204 that converge toward a virtual camera 210 having a view direction 214. As shown, in some embodiments, the view frustum 201 can have first 206 and second 208 clipping surfaces. The view frustum 201 can have any suitable length in the virtual environment, including an infinite length, or any other suitable predetermined length. In some embodiments, the length of the frustum can be determined by the distance from the first clipping surface 206 to the second clipping surface 208. In some embodiments, the first clipping surface 206 can be a first (e.g., near) clipping plane, and the second clipping surface 208 can be a second (e.g., far) clipping plane. In some embodiments, the view direction 214 of the camera 210 can be perpendicular to the first 206 and/or second 208 clipping surfaces. In some embodiments, the first clipping surface 206 can be positioned at any distance between the virtual camera 210 and the second clipping surface 208. In some embodiments, the second clipping surface 208 can be positioned at any distance from the first clipping surface. As shown, the surface(s) 204 can extend from the first clipping surface 206 to the second clipping surface 208. In some embodiments, the first 206 and second 208 clipping surfaces, and the surface(s) 204 can be the boundaries of the view frustum 201 within the virtual environment.

In some embodiments, the mechanisms described herein can include determining whether the content item 222 is in the view frustum 201 of the virtual environment. In some embodiments, determining whether the content item 222 is in the view frustum 201 can include determining if the content item object 202 is in the view frustum. In some embodiments, determining whether the content item 222 is in the view frustum can include determining a first position 216 (e.g., a two-dimensional position, a three-dimensional position, etc.) at the content item 222 within the virtual environment. Based on this determination, the mechanism can compare the first position 216 at the content item 222 to the boundaries of the view frustum 201 to determine if the first position 216 at the content item 222 is in the view frustum 201 of the virtual environment. As shown in FIG. 2A, the first position 216 can be within the boundaries of the view frustum. Accordingly, in some embodiments, the mechanism can determine that the content item 222 is in the view frustum 201 of the virtual environment.

Turning to FIG. 2B, an example diagram 250 of the view frustum 201 including at least a portion of a second content item 272 is shown in accordance with some embodiments of the disclosed subject matter. As shown, the second content item 272 can be included in, or attached to, a second content item object 252. As shown, the second content item 272 is partially in the view frustum 201. As shown, a first portion 258 of the second content item 272 can be positioned in the view frustum 201, and a second portion 260 of the second content item 272 can be positioned outside the view frustum 201. As shown, the second content item 272 can intersect a surface 204 of the view frustum 201 along intersection 268 between the content item object 252 and a surface 204 of the view frustum 201. As shown, a first position 256 at the second content item 272 can be within the boundaries of the view frustum 201. As shown, a second position 262 at the second content item 272 is not within the boundaries of the view frustum 201. In some embodiments, if at least one position at a content item 272 is in the view frustum, the mechanism can include determining that the content item 272 is in the view frustum. Accordingly, since the first position 256 at the second content item 272 is in the view frustum 201, the mechanism according to some embodiments can include determining that the second content item 272 is in the view frustum 201.

FIG. 2C shows an example diagram 270 of a viewport 282 of a virtual environment in accordance with some embodiments of the disclosed subject matter. In some embodiments, the viewport 282 can include a projection of a region in a view frustum (e.g., 201 in FIGS. 2A and 2B) onto a surface perpendicular to a view direction (e.g., 214 in FIG. 2A) of a virtual camera (e.g., 210 in FIGS. 2A and 2B). In some embodiments, a mechanism according to some embodiments of the disclosed subject matter can determine if a content item 280 is at least presented on a rendered screen of the virtual environment by determining if the content item 280 is positioned within boundaries 284, 286, 288, 290 of the viewport 282. Any suitable processes can be used to determine if the content item 280 is positioned within the boundaries 284, 286, 288, 290 of the viewport 282. In some embodiments, determining if the content item 280 is positioned within the boundaries 284, 286, 288, 290 of the viewport 282 can include determining a first position (e.g., position 216 in FIG. 2A and/or positions 256 and 262 in FIG. 2B) at the content item 280 within the virtual environment (e.g., which can be a two-dimensional position or a three-dimensional position). Based on this determination, the mechanisms described herein can include determining a second position 292 (e.g., two-dimensional position) at the content item as projected onto a surface comprising the viewport 282, where the second position 292 is projected from the first position of the content item 280 within the virtual environment. In some embodiments, the second position 292 can be compared to the boundaries 284, 286, 288, 290 of the viewport to determine if the second position 292 at the content item is within the boundaries of the viewport of the virtual environment. If at least one position at the content item 280 (e.g., second position 292) is within the boundaries of the viewport 282, the mechanisms can include determining that the content item 280 is in the view frustum of the virtual environment. Otherwise, the mechanisms can include determining that the content item 280 is not in the view frustum of the virtual environment.

Turning back to FIG. 2A, in some embodiments, the mechanisms can determine an angle between the view direction 214 of the virtual camera 210 and a first orientation vector 218 of the content item 222. As shown, in some embodiments, the first orientation vector 218 can be perpendicular to the content item 222 at the first position 216. In some embodiments, the mechanisms can determine an angle between a second orientation vector 220 of the content item 222 and a third orientation vector 232 of the virtual camera 210. In some embodiments, the second orientation vector 220 can be parallel to the content item 222 at the first position 216. In some embodiments, the third orientation vector 232 can be perpendicular to the view direction 214 of the virtual camera 210. In some embodiments, the view direction 214 of the virtual camera 210 can be considered as an orientation vector of the virtual camera 210.

Turning to FIG. 3, an example illustration 300 of a mechanism for determining one or more angles between a first set of orientation vectors and a second set of orientation vectors is shown in accordance with some embodiments of the disclosed subject matter. In some embodiments, the first set of orientation vectors can include a first orientation vector 312, a second orientation vector 314, a third orientation vector 316, any additional orientation vector(s), or any combination thereof. In some embodiments, the first set of orientation vectors can be orientation vectors of any object (e.g., content item 222 in FIG. 2A, content item object 202 in FIG. 2A) in the virtual environment. In some embodiments, if a content item is attached to a content item object, orientation vectors of the content item object can be considered as orientation vectors of the content item.

As shown, in some embodiments, the first set of orientation vectors can define a first Cartesian coordinate system having an x1-axis, y1-axis, and z1-axis. While three orientation vectors 312, 314, and 316 are shown, any suitable number of (e.g., one, two, three, etc.) orientation vectors can be used to at least partially define an orientation of any object in the virtual environment. In some embodiments, the first set of orientation vectors can include any vector parallel to any surface of an object, any vector perpendicular to any surface of the object, any other vector that can at least partially define an orientation of the object, or any combination thereof. In some embodiments, any vector of the first set of orientation vectors can be fixed to any surface of the object. As shown, any vector of the first set of orientation vectors can be perpendicular to any other vector of the first set of orientation vectors.

In some embodiments, the second set of orientation vectors can include a fourth orientation vector 322, a fifth orientation vector 324, a sixth orientation vector 326, any additional orientation vector(s), or any combination thereof. In some embodiments, the fourth 322, fifth 324, and sixth 326 orientation vectors can define a second Cartesian coordinate system having an x2-axis, y2-axis, and z2-axis. In some embodiments, the second set of orientation vectors can be orientation vectors of any other object in the virtual environment. For example, the second set of orientation vectors can be orientation vectors of a virtual camera (e.g., 210 in FIG. 2A) in the virtual environment. While three orientation vectors 322, 324, and 326 are shown, any suitable number of orientation vectors can be used to at least partially define an orientation of the virtual camera in the virtual environment. In some embodiments, any vector of the second set of orientation vectors can be parallel to a view direction (e.g., 214 in FIG. 2A) of the virtual camera. In some embodiments, the second set of orientation vectors can include the view direction of the virtual camera. In some embodiments, any vector of the second set of orientation vectors can be perpendicular to any other vector of the second set of orientation vectors.

As shown, in some embodiments, the first vector 312 and the second vector 314 of the first set of orientation vectors can define a first plane 310. As shown, in some embodiments, the fourth vector 322 and a fifth vector 324 of the second set of orientation vectors can define a second plane 320. As shown, in some embodiments, an intersection between the first plane 310 and the second plane 320 can define a normal vector N 330. In some embodiments, the normal vector N 330 can be normal to the third vector 316 of the first set of orientation vectors and normal to the sixth vector 326 of the second set of orientation vectors.

In some embodiments, a first angle 332 between the first vector 312 and the normal vector N 330 can be determined, the first angle 332 having a value of a. In some embodiments, a second angle 334 between the fourth vector 322 and the normal vector N 330 can be determined, the second angle 334 having a value of y. In some embodiments, a third angle 336 between the third vector 316 and sixth vector 326 can be determined, the third angle 336 having a value of B. In some embodiments, the first 332, second, 334, and third 336 angles can be considered as Euler angles. In some embodiments, any angle between any vectors of the first and second sets of orientation vectors can be determined using any suitable mathematical technique. For example, geometry (e.g., law of cosines, etc.), matrix and/or vector algebra, and/or any other suitable mathematical technique can be used to determine any angle. In some embodiments, a quaternion equivalent to any angle can be determined.

As shown, in some embodiments, the virtual environment can include a third Cartesian coordinate system having an x3-axis 350, y3-axis 352, and z3-axis 354. In some embodiments, any orientation vector of the first or second set of orientation vectors can be a vector projected onto any surface, including a plane, so that the angle between the orientation vector and another orientation vector is an angle between these vectors as projected onto the surface. For example, if an orientation vector is projected onto an x3-y3 plane, the angle between the orientation vector and another orientation vector can be considered as an x3-y3 angle. In some embodiments, an orientation vector of any object can be projected onto a surface parallel to an x3-y3 plane, an x3-z3 plane, a y3-z3 plane, or any combination thereof. Accordingly, in some embodiments, the angle can include an x3-y3 angle, x3-z3 angle, y3-z3 angle, or any combination thereof. In some embodiments, the angle can be represented in any suitable units. For example, the angle can be represented in radians, degrees, etc. As another example, the angle can be represented by one or more quaternions.

Turning back to FIG. 2A, a mechanism according to some embodiments of the disclosed subject matter can determine an on-screen real estate of the content item 222 based on a position of the content item 222 in the virtual environment. In some embodiments, the on-screen real estate of the content item 222 can be at least partially based on any length of the content item, measured along any direction. In some embodiments, a length of the content item 222 can be a length measured along any direction perpendicular to the view direction 214 of the virtual camera 210.

In some embodiments, a first length 228 of the content item 222 can be measured along a first direction 224 perpendicular to the view direction 214 of the virtual camera 210. In some embodiments, the on-screen real estate can be at least partially based on a second length 230 of the content item 222 measured along a second direction 226 perpendicular to the view direction 214 of the virtual camera 210. In some embodiments, the first direction 224 can be perpendicular to the second direction 226. In some embodiments, the on-screen real estate can be at least partially based on a first distance between the content item 222 and the virtual camera 210, a second distance between the content item 222 and the first clipping surface 206 of the view frustum 201, a third distance between the content item 222 and the second clipping surface 208 of the view frustum 201, a field of view of the virtual camera (e.g., angle between surfaces 204 of the view frustum), or any combination thereof. In some embodiments, the on-screen real estate can be based on a comparison between any length of the content item 222 and the first distance, the second distance, the third distance, or any combination thereof.

FIG. 4 shows an example illustration 400 of collision points 420-435 at a content item 402, according to some embodiments of the disclosed subject matter. In some embodiments, the collision points 420-435 can be points at which virtual rays (e.g., 531-534 in FIG. 5) collided with the content item 402. In some embodiments, the collision points 420-435 can be used to determine an on-screen real estate of the content item 402. In some embodiments, a length (e.g., first length 454, second length 456) of the content item 402 can be determined by casting virtual rays toward the content item 402. As shown, in some embodiments, the content item 402 can be attached to a content item object 412.

In some embodiments, a first virtual ray can be directed from a virtual camera (e.g., 210 in FIG. 2A) toward the content item 402 and collide with the content item 402 at collision point 420. In some embodiments, a first set of virtual rays can be directed from the virtual camera toward any suitable first target shape, such as, for example, first ellipse 440, and collide with the content item 402 at collision points 421-425. In some other embodiments, the first target shape can include a circle, triangle, square, rectangle, polygon, etc. In some embodiments, the first target shape can be centered around a path of the first virtual ray. In some embodiments, the first target shape can define a plane perpendicular to a view direction (e.g., view direction 214 in FIG. 2A) of the virtual camera. In some embodiments, the first target shape can be positioned at any suitable distance from the virtual camera. In some embodiments, the first target shape can be centered around the collision point 420.

In some embodiments, a second set of virtual rays can be directed from the virtual camera toward any suitable second target shape such as, for example, second ellipse 450, and collide with the content item 402 at collision points 426-435. In some other embodiments, the second target shape can include a circle, triangle, square, rectangle, polygon, etc. In some embodiments, the second target shape can have a larger length than the first target shape. In some embodiments, the second target shape can be centered around the path of the first virtual ray. In some embodiments, the second target shape can define a plane perpendicular to the view direction of the virtual camera. In some embodiments, the second target shape can be positioned at any suitable distance from the virtual camera. In some embodiments, the second target shape can be centered around the collision point 420.

In some embodiments, the first length 454 of the content item 402 can be a length measured along a first direction (e.g., x-direction indicated by coordinate system 452) perpendicular to the view direction of the virtual camera. In some embodiments the first length 454 can be determined by determining a length of the second ellipse 450 along the first direction perpendicular to the view direction. In some embodiments, the first length 454 can be determined by determining a first distance between a first collision point 428 and a second collision point 433. In some embodiments, since the distance from the virtual camera to the surface of the content item 402 can vary (e.g., distance measured along the z-direction), the first distance can be multiplied or divided by any suitable factor to determine the first length 454. For example, a suitable factor can include a sine of an angle between the view direction of the camera and a vector parallel to the vector defined by the first 428 and second 433 collision points. However, any other suitable mathematical technique involving for example trigonometric relations can be used to determine the first length 454.

In some embodiments, the second length 456 of the content item 402 can be a length measured along a second direction (e.g., y-direction) perpendicular to the view direction of the virtual camera. In some embodiments, the second length 456 can be determined by determining a second length of the second ellipse 450 along the second direction perpendicular to the view direction. In some embodiments, the second direction can be perpendicular to the first direction. In some embodiments, the second length 456 can be determined by determining a second distance between a third collision point 431 and a fourth collision point 435. In some embodiments, since the distance from the virtual camera to the surface of the content item 402 can vary (e.g., distance measured along the z-direction), the second distance can be multiplied or divided by any suitable factor to determine the second length 456. For example, a suitable factor can include a sine of an angle between the view direction of the camera and a vector parallel to the vector defined by the third 431 and fourth 435 collision points. However, any other suitable mathematical technique involving for example trigonometric relations can be used to determine the second length 456.

In some embodiments, the on-screen real estate of the content item 402 can be at least partially based on the first 454 and/or second 456 lengths of the content item 402.

Turning back to FIG. 2C, in some embodiments, an amount of the content item 280 presented on a rendered screen can be determined based on dimensions of the content item 280 in the viewport 282, the dimensions of the viewport 282, or a combination thereof. For example, the dimensions of the content item 280 can include the width 298 and length 299 of the content item 280 in the viewport 282, and the area can be determined by a product of the width 298 and length 299. In some embodiments, determining an amount of the content item 280 in a rendered screen can include comparing the dimensions of the content item 280 in the viewport 282 to the dimensions of the viewport 282. In some embodiments, determining an amount of the content item 280 in a rendered screen can include comparing a first area of the content item 280 in the viewport 282 to a second area (e.g., entire area) of the viewport 282. In some embodiments, the amount can be a ratio between the first area and the second area.

In some embodiments, the dimensions of the content item 280 can be determined by any suitable process. In some embodiments, the dimensions of the content item 280 in the viewport 282 can be determined by mapping positions at the content item 280 within the virtual environment to positions 294-297 of the content item 280 on the viewport 282, and determining any suitable distances between any points in points 294-297. In some embodiments, the points 294-297 can be points located at edges of the content item 280 on the viewport 282.

FIG. 5 shows an example diagram 500 of casting virtual rays 531-539 from a virtual camera 510, in accordance with some embodiments of the disclosed subject matter. In some embodiments, the virtual rays 531-537 can be directed toward the content item 522. In some embodiments, the virtual rays 531-537 can be casted to determine if the content item 522 is at least partially presented on a rendered screen of the virtual environment. In some embodiments, the virtual rays 531-539 can be casted to determine an amount (e.g., proportion) of a rendered screen occupied by the content item 522. In some embodiments, the virtual rays 531-539 can be directed within a view frustum (e.g., view frustum 201 in FIGS. 2A and 2B). In some embodiments, the virtual rays 531-539 can be directed toward a second clipping surface (e.g., 208 in FIGS. 2A and 2B) of the view frustum. In some embodiments, the virtual rays 531-539 can be directed toward locations distributed uniformly across the second clipping surface.

As shown, in some embodiments, the content item 522 can be attached to a content item object 502. As shown, in some embodiments, the content item 522 can include any text and graphics that can be used for advertising. As shown, in some embodiments, an object such as occluding object 520, can be positioned between the virtual camera 510 and the content item 522. The occluding object 520 can be any suitable object in the virtual environment having any suitable size, shape, dimensions, texture(s), transparency, and/or any other suitable object property.

In some embodiments, a virtual ray can be a ray generated within the virtual environment for colliding with one or more objects that are programmed to collide with virtual rays, and that are positioned within a path of the virtual ray. In some embodiments, a virtual ray can collide with a single object, or can collide with more than one object positioned along a path of the virtual ray. In some embodiments, mechanisms according to some embodiments of the disclosed subject matter can determine if any collision between a virtual ray and any object is a primary collision. In some embodiments, a primary collision can be a collision between a virtual ray and an object, wherein no collision between the virtual ray and any object is located between the primary collision and the virtual camera. A primary collision located at the content item 522 can indicate that no object is positioned between the content item 522 and the virtual camera 510 along the path of the virtual ray that collided with the content item 522 at the primary collision.

If a virtual ray does not collide with another object along its path between the virtual camera and the content item 522, and if the virtual ray collides with the content item 522 at a collision point, at least the collision point on the content item 522 can be presented on a rendered screen of the virtual environment. Multiple collision points on a portion of the content item 522 can indicate that at least the portion of the content item 522 is presented on a rendered screen of the virtual environment.

As shown, in some embodiments, a first set of virtual rays 531-534 can collide with the content item 522 at respective collision points 541-544, indicating that a first portion of the content item 522 can be presented on a rendered screen of the virtual environment. As shown, a second set of virtual rays 535-537 can collide with the occluding object 520 at respective collision points 545-547, indicating that a second portion of the content item 522 is obstructed by the occluding object 520. Accordingly, in some embodiments, the occluding object 520 can prevent the second portion of the content item 522 from being presented on the rendered screen of the virtual environment. In some embodiments the collision points 531-537 can be primary collision points. In some embodiments, a primary collision point can be a point at which a virtual ray collides with an object, wherein no collision between the virtual ray and any object is located between the primary collision point and the virtual camera. As shown, in some embodiments, a third set of virtual rays 538-539 do not collide with the content item 522 or the occluding object 520. In some embodiments, the third set of virtual rays 538-539 do not collide with any object in the view frustum.

In some embodiments, mechanisms according to some embodiments of the disclosed subject matter can determine an amount of the content item 522 presented on a rendered screen of the virtual environment. In some embodiments, the amount of the content item 522 can be based on the first number of virtual rays in the first set of virtual rays 531-534, the second number of virtual rays in the second set of virtual rays 535-537, the third number of virtual rays in the third set of virtual rays 538-539, a sum of the first and second numbers, a sum of the first, second, and third numbers, or any combination thereof. In some embodiments, mechanisms can determine that the content item is at least partially presented on a rendered screen if a predetermined amount of virtual rays collide with the content item 522.

In some embodiments, a proportion of the rendered screen occupied by the content item 522 can be based on the first number of virtual rays in the first set of virtual rays 531-534, the second number of virtual rays in the second set of virtual rays 535-537, the third number of virtual rays in the third set of virtual rays 538-539, a sum of the first, second, and third numbers, or any combination thereof. In some embodiments, the proportion can be based on a ratio between the first number of virtual rays and the sum of the first, second, and third numbers.

In some embodiments, any suitable information can be recorded when casting virtual rays 531-539. For example, in some embodiments, distances and/or angles traveled by virtual rays, the position of any collision, any suitable information regarding any collided object such as a pixel (and/or voxel) color value, a texture applied to a region including the collision point, etc., can be recorded. In some embodiments, the position of a content item 522 can be determined by determining the position of any collision between the content item 522 and a virtual ray.

In some embodiments, any suitable quantity of virtual rays that originate from any suitable positions can be casted. In some embodiments, a uniform distribution of virtual rays restricted to any suitable angles within the view frustum can be casted. In some embodiments, any suitable mathematical function can be used to distribute the virtual rays. In some embodiments, a more dense distribution of virtual rays can be directed toward the content item 522 relative to other directions. In some embodiments, if a non-uniform distribution of virtual rays is used, a distribution function can be used to add any suitable weight to the virtual rays.

In some embodiments, some visual elements (including user interface elements and some objects) may not be programmed to collide with virtual rays. For example, in some embodiments, the visual elements can include a virtual particle system such as a virtual cloud, fog, smoke, steam, fire, rain, snow, debris, etc., or any other visual element that can at least partially obstruct the content item on a rendered screen. In some embodiments, a first plurality of pixels of a content item can be compared to a second plurality of pixels of an image (e.g., frame) of a rendered screen of the virtual environment to determine if the content item is at least partially presented on the rendered screen of the virtual environment.

FIG. 6 shows an example diagram of a mechanism for selecting a first plurality of pixels of a content item 600 in accordance with some embodiments of the disclosed subject matter. While five selected pixels 604, 606, 608, 610, and 612 are shown in FIG. 6, any suitable number of pixels of the content item 600 can be selected in some embodiments. In some embodiments, pixels of the content item 600 can be selected based on positions of the pixels. In some embodiments, the positions of the pixels of the content item 600 can be positions of the pixels on a rendered screen of the virtual environment, positions of the pixels within the content item 600, positions of the pixels within the content item 600 as projected onto any surface (e.g., of a viewport), or any combination thereof. In some embodiments, the positions of the pixels can be two-dimensional positions.

In some embodiments, the positions of the pixels can be determined by selected positions (e.g., position 216 in FIG. 2A and/or position 256 in FIG. 2B) at the content item 600 within the virtual environment (e.g., which can be a two-dimensional position or a three-dimensional position), where the selected positions have the same number of dimensions as the virtual environment. In some embodiments, selecting the first plurality of pixels of the content item 600 can include projecting the selected positions at the content item 600 within the virtual environment to respective positions onto any surface (e.g., of the viewport of the virtual environment), and selecting the first plurality of pixels located at the respective positions of the surface.

As shown, pixels positioned along a majority of the length 622 of the content item 600 can be selected. As shown, at least one pixel 610 positioned proximate to a center 620 of the content item 600 can be selected. In some embodiments, a pixel proximate to the center 620 can be a pixel located at the center 620 of the content item 600.

In some embodiments, selecting the first plurality of pixels can include determining two or more distinct regions 614, 616, 618, etc. of the content item. In some embodiments, the two or more regions 614, 616, 618, etc. can be determined based on the colors of the pixels of the content item. In some embodiments, the two or more regions 614, 616, 618, etc. can be distinct regions of color in the content item 600. In some embodiments, any suitable process, including for example implementing a machine learning model, can be performed to determine the colors of the pixels of the content item, and determine two or more distinct regions based on the colors of the pixels of the content item 600.

In some embodiments, the two or more regions 614, 616, 618, etc. can be determined based on the dimensions of the content item 600. In some embodiments, determining the two or more regions can include dividing a first dimension (e.g., length 622) of the content item 600 by any suitable first number, dividing a second dimension (e.g., height 624) of the content item 600 by any suitable second number, and determining the two or more regions based on the divisions.

While nine regions 614, 616, 618, etc. of approximately the same size are shown in FIG. 6, in some embodiments, any suitable number of regions of approximately the same size or any suitable number of regions of different sizes can be determined. While the two or more regions 614, 616, 618, etc. are shown as being rectangular, the two or more regions can have any shape. For example, the two or more regions 614, 616, 618, etc. can be triangular, square, polygonal, circular, elliptical, etc., or any combination thereof. In continuing this example, the two or more regions can have any suitable irregular shape.

As shown, pixels 604, 606, 608, 610, and 612 in respective regions of the content item 600 can be selected as the first plurality of pixels. As shown, at least one pixel 610 positioned proximate to a center 620 of a respective region 618 of the content item 600 can be selected. In some embodiments, any pixels of the content item located at any positions can be selected as the first plurality of pixels. In some embodiments, any pixels of the content item can be randomly selected as the first plurality of pixels.

FIG. 7 shows an example mechanism for comparing a second plurality of pixels 704, 706, 708, 710, and 712 of a first image 700 of a rendered screen of a virtual environment with a first plurality of pixels (e.g. 604, 606, 608, 610, and 612 in FIG. 6) of a content item 718, according to some embodiments of the disclosed subject matter. In some embodiments, the first image 700 of the rendered screen can be captured while the virtual environment changes with time. For example, the first image 700 of the rendered screen can be captured while a user is controlling a virtual camera in the virtual environment. In some embodiments, the first image 700 of the rendered screen can be captured within a predetermined amount of time from when a user moves the virtual camera in the virtual environment, thereby changing a position and/or orientation of a view frustum of the virtual environment.

As shown, in some embodiments, any suitable virtual objects positioned within the view frustum of the virtual environment can be presented on the rendered screen of the virtual environment. As shown, the virtual environment can be three-dimensional, and can comprise any suitable virtual objects such as a content item object 702, a virtual road 714, or a combination thereof, positioned within the view frustum. In some embodiments, the content item object 702 can comprise, or be attached to, a content item 718 such as an image, a video, a frame of a video, a sequence of frames of a video, etc., or any combination thereof. In some embodiments, the content item 718 can include text, graphics, symbols, logos, etc. that can be used to advertise a particular company, brand, product, service, etc.

As shown, the content item object 702 can include any suitable virtual object for advertising a company, brand, product, service, etc. As shown, in some embodiments, the content item object 702 can be a virtual billboard. However, in other embodiments, the content item object 702 can include any other suitable virtual object. In some embodiments, the content item object 702 can include a virtual sign, poster, sticker, printed material, etc., or any combination thereof. In some embodiments, the content item object 702 can include any suitable virtual display devices, such as a virtual touchscreen, flat-panel display, cathode ray tube display, projector system, any other suitable display and/or presentation devices, etc., or any combination thereof. In some embodiments, the content item object 702 can be presented as a two-dimensional or three-dimensional object. In some embodiments, the virtual content item object 702 can include a hologram. In some embodiments, the content item object 702 can be presented on or in any two-dimensional or three-dimensional object within the virtual environment.

As shown, the content item object 702 can be positioned proximate to the virtual road 714. However, in other embodiments, the content item object 702 can be positioned proximate to any other virtual object(s) in the virtual environment. In some embodiments, the content item object 702 can be positioned at any position that can be viewed by a virtual camera within the virtual environment.

Mechanisms according to some embodiments of the disclosed subject matter can include selecting the second plurality of pixels 704, 706, 708, 710, and 712 of the image 700 of the rendered screen of the virtual environment. While five pixels 704, 706, 708, 710, and 712 are shown in FIG. 7, any suitable number of pixels of the image 700 of the rendered screen can be selected in some embodiments. Any suitable process can be used to make the selection of the second plurality of pixels.

In some embodiments, the second plurality of pixels of the image 700 of the rendered screen can be selected to correspond to respective pixels of a first plurality of pixels (e.g. 604, 606, 608, 610, and 612 in FIG. 6) of the content item 718. In some embodiments, the second plurality of pixels of the image 700 of the rendered screen can be selected based on (e.g., two-dimensional) positions of the first plurality of pixels within the content item 718.

In some embodiments, the second plurality of pixels of the image 700 of the rendered screen can be selected based on selected positions (e.g., position 216 in FIG. 2A and/or position 256 in FIG. 2B) at the content item 718 within the virtual environment (e.g., which can be a two-dimensional position or a three-dimensional position). In some embodiments, selecting the second plurality of pixels of the image 700 can include projecting selected positions (e.g., position 216 in FIG. 2A and/or position 256 in FIG. 2B) at the content item 718 to respective positions on the rendered screen of the virtual environment, and selecting the second plurality of pixels located at the respective positions on the rendered screen of the virtual environment.

In some embodiments, the first plurality of pixels of the content item 718 can be mapped onto respective positions in the virtual environment based on an orientation and position(s) of the content item object 702 in the virtual environment. In some embodiments, the content item object 702 can be generated so that portions of the content item object 702 within the virtual environment are located at a first predetermined position 720, a second predetermined position 722, a third predetermined position 724, etc., or any combination thereof. In some embodiments, the boundaries of the content item object 702 within the virtual environment can be located at one or more of the first 720, second 722, and third 724 predetermined positions. In some embodiments, the first 720, second 722, and third 724 predetermined positions can define boundaries of the content item object 702. In some embodiments, the first predetermined position 720 can be located at an upper boundary and left boundary of the content item object 702. In some embodiments, the second predetermined position 722 can be located at the left boundary and lower boundary of the content item object 702. In some embodiments, the third predetermined position 724 can be located at the upper and right boundaries of the content item object 702. In some embodiments, the first plurality of pixels can be mapped onto respective positions in the virtual environment based on the boundaries of the content item object 702 within the virtual environment.

In some embodiments, the first plurality of pixels can be mapped onto respective positions in the virtual environment based on comparison of an orientation of the content item object 702 in the virtual environment and an orientation of a virtual camera in the virtual environment. In some embodiments, the rendered screen of the virtual environment can include at least a portion of a viewport of the virtual environment, which can present a region of the virtual environment from a perspective of a position of the virtual camera. In some embodiments, the first 720, second 722, and third 724 predetermined positions can determine an orientation of the content item object 502 within the virtual environment. In some embodiments, the first 720, second 722, and third 724 predetermined positions can define a plane parallel to a surface of the content item object 702, thereby defining an orientation of the content item object 702.

In some embodiments, the orientation of the camera can be determined by a view direction of the virtual camera within the virtual environment, a plane perpendicular to the viewing direction of the camera, any clipping surface of the view frustum, any other suitable vector or plane that can determine the orientation of the view of the camera, or any combination thereof.

In some embodiments, the orientation of any object in the virtual environment, including the content item object 702 and the camera in the virtual environment, can be determined by any suitable vectors, planes, angles, complex numbers, quaternions, etc., or any combination thereof. Suitable vectors or planes can include any vector or plane perpendicular to any surface of an object, any vector or plane parallel to any surface of an object, or any combination thereof. In some embodiments, the virtual environment can comprise any suitable number of coordinate axes. In some embodiments, the virtual environment can comprise any suitable type of coordinate axes, such as cartesian coordinate axes, spherical coordinate axes, cylindrical coordinate axes, etc., or any combination thereof. In some embodiments, each object of the virtual environment can be associated with a respective set of coordinate axes.

In some embodiments, mapping the positions of the first plurality of pixels of the content item 718 can be based on a size and a position of the content item object 702 in the virtual environment. In some embodiments, the first 720, second 722, and third 724 predetermined positions of the content item object 702 can determine the size of the content item object 702 in the virtual environment. In some embodiments, the on-screen real estate can be determined by determining distances to one or more of the first 720, second 722, and third 724 predetermined positions at the content item object 702 within the virtual environment.

Mechanisms according to some embodiments can include comparing color values of a first plurality of pixels (e.g. 604, 606, 608, 610, and 612 in FIG. 6) of the content item 718 with color values of the second plurality of pixels 704, 706, 708, 710, and 712 of the image 700 of the rendered screen.

In some embodiments, the intensity of each color of any pixel of the content item 718 or the image 700 of the rendered screen can be determined by any suitable color value in any suitable range. Further, a pixel can have any suitable colors. In some embodiments, each pixel of the content item 718 or the image 700 of the rendered screen can be associated with any suitable combination of color values. For example, color values can include a red value, a green value, a blue value, a cyan value, a magenta value, a yellow value, a black value, a white value, etc., or any combination thereof. As another example, a suitable combination of color values can include 1) red, green, blue (RGB) values, 2) cyan, magenta, yellow, and black (CMYK) color values, 3) grayscale values, etc., or any combination thereof. Each color value (e.g., red color value, green color value, cyan color value, black color value, etc.) can indicate the intensity of a respective color of a pixel of the content item. Further, if a pixel comprises subpixels, each color value can indicate the intensity of a color of a respective subpixel of a pixel of the content item. For example, as the intensity of each RGB color value can be represented by a number in any suitable range, such as the range from 0 to 255, a white RGB pixel can be represented by RGB values (255, 255, 255). In continuing this example, a black RGB pixel can be represented by RGB values (0, 0, 0). In further continuing this example, a red RGB pixel can be represented by RGB values (255, 0, 0). However, the same pixels can be represented by different color values (e.g., CMYK color values, grayscale color values, etc.), and by different numbers of color values in some embodiments.

In some embodiments, comparing a first plurality of color values of the first plurality of pixels with a second plurality of color values of the second plurality of pixels can include determining if the first plurality of color values and the second plurality of color values are approximately the same. In some embodiments, comparing the first plurality of color values with the second plurality of color values can include determining a proportion of the first plurality of color values that are determined to be approximately the same as the second plurality of color values. Any suitable processes can be performed to compare the first plurality of color values with the second plurality of color values. For example, comparing the color values can include determining differences between any of the first plurality of color values and any of the second plurality of color values, summing the differences, summing weighted differences, determining a mean of the differences, determining quotients between any of the first plurality of color values and any of the second plurality of color values, summing the quotients, summing weighted quotients, determining a mean of the quotients, determining a mean squared error between the first plurality of color values and the second plurality of color values, determining a root mean squared error between the first plurality of color values and the second plurality of color values, any other suitable process that can compare the first plurality of color values and the second plurality of color values, or any combination thereof. If the first and second pluralities of color values are determined to be approximately the same, mechanisms can determine that the first and second pluralities of pixels are approximately the same in color.

As shown in FIG. 7, first visual elements such as user interface elements 732 can be positioned in the rendered screen. As shown, the user interface elements 732 can include a health meter and associated text. As shown, the user interface elements 732 do not obstruct the content item 718 in the image 700 of the rendered screen. However, in other embodiments, the user interface elements 732 can at least partially obstruct a portion of the content item 718 in the image 700 of the rendered screen of the virtual environment.

As shown, a second visual element 716 can at least partially obstruct the content item 718 in the image 700 of the rendered screen. The second visual element 716 can be any visual element that can at least partially obstruct the content item 718 when presented on a rendered screen. For example, in some embodiments, the visual element 716 can include a virtual particle system such as a virtual cloud, fog, smoke, steam, fire, rain, snow, debris, etc., or any other visual element that can at least partially obstruct the content item 718 from the perspective of a virtual camera. In other embodiments, the second visual element 716 can include any user interface elements. In other embodiments, the second visual element 716 can include any other object.

In some embodiments, the color(s) of the visual element 716 can be different from the color(s) of the content item 718. Accordingly, as the visual element 716 is at least partially covering the content item 718, the color values of at least a first set of pixels (e.g., pixels 706, 710, 712) of the second plurality of pixels of the first image 700 of the rendered screen can be determined to be approximately not the same as color values of respective pixels of the first plurality of pixels. In response, mechanisms according to some embodiments can include determining that the content item 718 being presented within the virtual environment is being obstructed by the visual element 716 based on the comparison of the color values. In some embodiments, mechanisms can determine that the content item 718 is being at least partially presented on the rendered screen based on the comparison of the color values.

While three pixels (e.g., pixels 706, 710, 712) are shown to be different in color, mechanisms according to some embodiments can include determining that the content item 718 is being obstructed if any suitable number of pixels of the second plurality of pixels are determined to be different in color than respective pixels of the first plurality of pixels. In some embodiments, mechanisms can determine that the content item 718 is being at least partially presented if any suitable number or proportion (e.g., >50%) of pixels of the second plurality of pixels are determined to be the same in color as respective pixels of the first plurality of pixels.

In some embodiments, the visual element 716 can be deleted or moved relative to the content item object 702. FIG. 8 shows a second image 800 of a second rendered screen of the virtual environment which is the same as the first image 700 shown in FIG. 7, except that the second image 800 does not show the visual element 716, according to some embodiments of the disclosed subject matter. Accordingly, in some embodiments, the visual element 716 does not obstruct the content item 718 in the image 800 of the rendered screen of the virtual environment. In other embodiments, the position of the content item 718 on the rendered screen can change relative to the visual element 716 as the perspective of the virtual camera changes. Accordingly in other embodiments, the visual element may not obstruct the content item 718 on the rendered screen after the position and/or orientation of the virtual camera changes.

As the visual element 716 is not obstructing the content item 718 in the image 800, the color values of a second plurality of pixels 804, 806, 808, 810, 812 of the second image 800 of the rendered screen can be determined to be approximately the same as the color values of respective pixels of the first plurality of pixels. In response, mechanisms according to some embodiments can include determining that the content item 718 being presented within the virtual environment is not being obstructed by a visual element based on the comparison of the color values in the image 800. In some embodiments, if all pixels of the second plurality of pixels are determined to be approximately the same in color as respective pixels of the first plurality of pixels, mechanisms can determine that the content item is being at least partially presented on the rendered screen of the virtual environment.

Turning to FIG. 9, an example system 900 for screening users of a virtual environment is shown in accordance with some embodiments of the disclosed subject matter. As illustrated, system 900 can include a server 902, a communication network 904, one or more user devices 906 (e.g., such as user devices 908 and 910), or any suitable combination thereof.

Server 902 can be any suitable server(s) for storing information, data, programs, media content, and/or any other suitable content. In some embodiments, server 902 can perform any suitable function(s).

Communication network 904 can be any suitable combination of one or more wired and/or wireless networks in some embodiments. For example, communication network can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 906 can be connected by one or more communications links (e.g., communications links 912) to communication network 904 that can be linked via one or more communications links (e.g., communications links 914) to server 902. The communications links can be any communications links suitable for communicating data among user devices 906 and server 902 such as network links, dial-up links, wireless links, hard-wired links, any other suitable communications links, or any suitable combination of such links.

User devices 906 can include any one or more user devices suitable for implementing the mechanisms described herein. In some embodiments, user device 906 can include any suitable type of user device, such as mobile phones, tablet computers, wearable computers, laptop computers, desktop computers, smart televisions, media players, game consoles, vehicle information and/or entertainment systems, and/or any other suitable type of user device.

For example, user devices 906 can include any one or more user devices suitable for requesting video content, rendering the requested video content as immersive video content (e.g., as virtual reality content, as three-dimensional content, as 360-degree video content, as 180-degree video content, and/or in any other suitable manner) and/or for performing any other suitable functions. For example, in some embodiments, user devices 706 can include a mobile device, such as a mobile phone, a tablet computer, a wearable computer, a laptop computer, a virtual reality headset, a vehicle (e.g., a car, a boat, an airplane, or any other suitable vehicle) information or entertainment system, and/or any other suitable mobile device and/or any suitable non-mobile device (e.g., a desktop computer, a game console, and/or any other suitable non-mobile device). As another example, in some embodiments, user devices 706 can include a media playback device, such as a television, a projector device, a game console, desktop computer, and/or any other suitable non-mobile device.

In a more particular example where user device 906 is a head mounted display device that is worn by the user, user device 906 can include a head mounted display device that is connected to a portable handheld electronic device. The portable handheld electronic device can be, for example, a controller, a smartphone, a joystick, or another portable handheld electronic device that can be paired with, and communicate with, the head mounted display device for interaction in the immersive environment generated by the head mounted display device and displayed to the user, for example, on a display of the head mounted display device.

It should be noted that the portable handheld electronic device can be operably coupled with, or paired with the head mounted display device via, for example, a wired connection, or a wireless connection such as, for example, a WiFi or Bluetooth connection. This pairing, or operable coupling, of the portable handheld electronic device and the head mounted display device can provide for communication between the portable handheld electronic device and the head mounted display device and the exchange of data between the portable handheld electronic device and the head mounted display device. This can allow, for example, the portable handheld electronic device to function as a controller in communication with the head mounted display device for interacting in the immersive virtual environment generated by the head mounted display device. For example, a manipulation of the portable handheld electronic device, and/or an input received on a touch surface of the portable handheld electronic device, and/or a movement of the portable handheld electronic device, can be translated into a corresponding selection, or movement, or other type of interaction, in the virtual environment generated and displayed by the head mounted display device.

It should also be noted that, in some embodiments, the portable handheld electronic device can include a housing in which internal components of the device are received. A user interface can be provided on the housing, accessible to the user. The user interface can include, for example, a touch sensitive surface configured to receive user touch inputs, touch and drag inputs, and the like. The user interface can also include user manipulation devices, such as, for example, actuation triggers, buttons, knobs, toggle switches, joysticks and the like.

The head mounted display device can include a sensing system including various sensors and a control system including a processor and various control system devices to facilitate operation of the head mounted display device. For example, in some embodiments, the sensing system can include an inertial measurement unit including various different types of sensors, such as, for example, an accelerometer, a gyroscope, a magnetometer, and other such sensors. A position and orientation of the head mounted display device can be detected and tracked based on data provided by the sensors included in the inertial measurement unit. The detected position and orientation of the head mounted display device can allow the system to, in turn, detect and track the user's head gaze direction, and head gaze movement, and other information related to the position and orientation of the head mounted display device.

In some implementations, the head mounted display device can include a gaze tracking device including, for example, one or more sensors to detect and track eye gaze direction and movement. Images captured by the sensor(s) can be processed to detect and track direction and movement of the user's eye gaze. The detected and tracked eye gaze can be processed as a user input to be translated into a corresponding interaction in the immersive virtual experience. A camera can capture still and/or moving images that can be used to help track a physical position of the user and/or other external devices in communication with/operably coupled with the head mounted display device. The captured images can also be displayed to the user on the display in a pass through mode.

Although server 902 is illustrated as one device, the functions performed by server 902 can be performed using any suitable number of devices in some embodiments. For example, in some embodiments, multiple devices can be used to implement the functions performed by server 902.

Although two user devices 908 and 910 are shown in FIG. 9 to avoid overcomplicating the figure, any suitable number of user devices, (including only one user device) and/or any suitable types of user devices, can be used in some embodiments.

In some embodiments, any combination of the subprocesses or processes described herein can be performed by the one or more user devices 906, server 902, or any combination thereof.

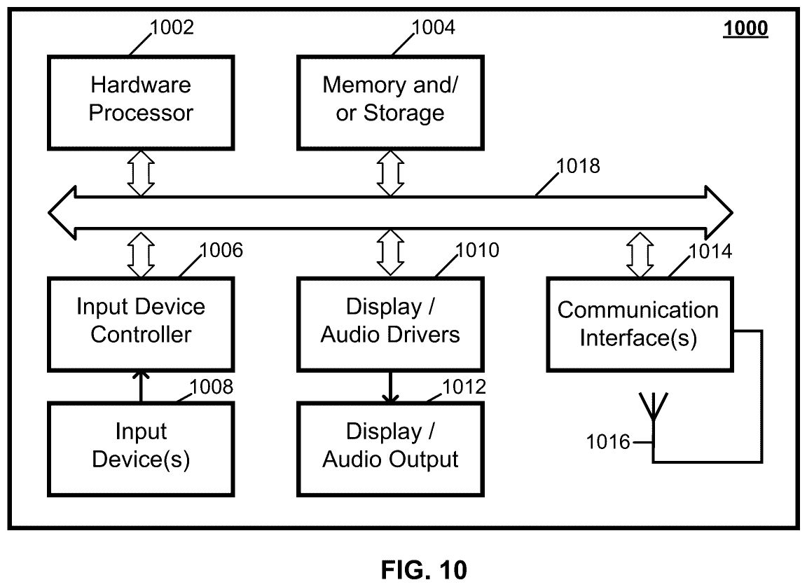

Server 902 and user devices 906 can be implemented using any suitable hardware in some embodiments. For example, in some embodiments, devices 902 and 906 can be implemented using any suitable general-purpose computer or special-purpose computer and can include any suitable hardware. For example, as illustrated in example hardware 1000 of FIG. 10, such hardware can include hardware processor 1002, memory and/or storage 1004, an input device controller 1006, an input device 1008, display/audio drivers 1010, display and audio output circuitry 1012, communication interface(s) 1014, an antenna 1016, and a bus 1018.

Hardware processor 1002 can include any suitable hardware processor, such as a microprocessor, a micro-controller, a multi-core processor or an array of processors, digital signal processor(s), dedicated logic, and/or any other suitable circuitry for controlling the functioning of a general-purpose computer or a special-purpose computer in some embodiments. In some embodiments, hardware processor 1002 can be controlled by a computer program stored in memory and/or storage 1004. For example, in some embodiments, the computer program can cause hardware processor 1002 to perform functions and methods described herein.

Memory and/or storage 1004 can be any suitable memory and/or storage for storing programs, data, documents, and/or any other suitable information in some embodiments. For example, memory and/or storage 1004 can include random access memory, read-only memory, flash memory, hard disk storage, optical media, and/or any other suitable memory.

Input device controller 1006 can be any suitable circuitry for controlling and receiving input from one or more input devices 1008 in some embodiments. For example, input device controller 1006 can be circuitry for receiving input from a touchscreen, from a keyboard, from a mouse, from one or more buttons, from a voice recognition circuit, from a microphone, from a camera, from an optical sensor, from an accelerometer, from a temperature sensor, from a near field sensor, from a gaming controller, and/or any other type of input device.

Display/audio drivers 1010 can be any suitable circuitry for controlling and driving output to one or more display/audio output devices 1012 in some embodiments. For example, display/audio drivers 1010 can be circuitry for driving a touchscreen, a flat-panel display, a cathode ray tube display, a projector, a speaker or speakers, and/or any other suitable display and/or presentation devices.

Communication interface(s) 1014 can be any suitable circuitry for interfacing with one or more communication networks, such as network 904 as shown in FIG. 9. For example, interface(s) 1014 can include network interface card circuitry, wireless communication circuitry, and/or any other suitable type of communication network circuitry.

Antenna 1016 can be any suitable one or more antennas for wirelessly communicating with a communication network (e.g., communication network 904 in FIG. 9) in some embodiments. In some embodiments, antenna 1016 can be omitted.

Bus 1018 can be any suitable mechanism for communicating between two or more components 1002, 1004, 1006, 1010, and 1014 in some embodiments.

Any other suitable components can be included in hardware 1000 in accordance with some embodiments.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory forms of magnetic media (such as hard disks, floppy disks, etc.), non-transitory forms of optical media (such as compact discs, digital video discs, Blu-ray discs, etc.), non-transitory forms of semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

It should be understood that at least some of the above-described subprocesses can be executed or performed in any order or sequence not limited to the order and sequence described herein. Also, at least some of the above subprocesses can be executed or performed substantially simultaneously where appropriate or in parallel to reduce latency and processing times. Additionally or alternatively, at least some of the above described subprocesses can be omitted.

Accordingly, methods, systems, and media for screening users in a virtual environment are provided.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for screening users items in virtual environments, the method comprising:
determining one or more first representative values of one or more first metrics for a first user, wherein the one or more first metrics are associated with one or more content items presented within a virtual environment and wherein the one or more first metrics includes: (i) angles between orientation vectors of one or more content items and view directions of one or more virtual cameras in the virtual environment, wherein the one or more virtual cameras are controlled by the first user; (ii) on-screen real estates of the one or more content items based on distances between the one or more content items and the one or more virtual cameras controlled by the first user; (iii) view duration in which a content item of the one or more content items was at least partially presented for the first user on a rendered screen of the virtual environment during a predetermined amount of time; and (iv) a comparison between the view duration and a duration in which the one or more virtual cameras were controlled by the first user during the predetermined amount of time;
in response to determining the one or more first representative values of the one or more first metrics, comparing the one or more first representative values to one or more corresponding reference values, wherein comparing the one or more first representative values to the one or more corresponding reference values comprises determining a fraud score based on the one or more first representative values and the one or more corresponding reference values;
in response to determining the fraud score, determining that the fraud score is within a first predetermined range of values; and
in response to determining that the fraud score is within the first predetermined range of values, determining that the first user in the virtual environment is a human user.

2. The method of claim 1, wherein the method further comprises:
in response to determining that the first user is a human user, storing an association between a first category indicating that the first user is a human user; and
storing a number of views associated with the first user.

3. The method of claim 1, wherein the one or more corresponding reference values are based on second representative values of one or more second metrics, wherein the one or more second metrics include: (i) second angles between the orientation vectors of the one or more content items and second view directions of one or more second virtual cameras in the virtual environment, the one or more second virtual cameras controlled by a plurality of users; (ii) second on-screen real estates of the one or more content items based on distances between the one or more content items and the one or more second virtual cameras controlled by the plurality of users; (iii) a second view duration in which the content item of the one or more content items was at least partially presented for the plurality of users on the rendered screen of the virtual environment during a predetermined amount of time; and (iv) a second comparison between the second view duration and a second duration in which the one or more second virtual cameras were controlled by the plurality of users during the predetermined amount of time.

4. The method of claim 1, wherein the determining of the one or more first representative values of the one or more first metrics for the first user is performed at a first time, and wherein the method further comprises:
determining one or more third representative values of the one or more first metrics for the first user at a second time;
in response to determining the one or more third representative values of the one or more first metrics, comparing the one or more third representative values to one or more corresponding second reference values, wherein comparing the one or more third representative values to the one or more corresponding second reference values comprises determining a second fraud score based on the one or more third representative values and the one or more corresponding second reference values;
in response to determining the second fraud score, determining that the second fraud score is within a second predetermined range of values;
in response to determining that the second fraud score is within the second predetermined range of values, determining that the first user is a nonhuman user; and
in response to determining that the first user is the nonhuman user, inhibiting the first user from accessing the virtual environment by removing one or more accounts associated with the first user.

5. The method of claim 1, wherein the one or more first representative values of the angles includes a mean value of the angles between the orientation vectors of the one or more content items and the view directions of the one or more virtual cameras in the virtual environment, and wherein the one or more first representative values of the on-screen real estates includes a mean value of the on-screen real estates of the one or more content items based on the distances between the one or more content items and the one or more virtual cameras controlled by the first user.

6. The method of claim 1, wherein the one or more first representative values of the angles includes a median value of the angles between the orientation vectors of the one or more content items and the view directions of the one or more virtual cameras in the virtual environment, and wherein the one or more first representative values of the on-screen real estates includes a median value of the on-screen real estates of the one or more content items based on the distances between the one or more content items and the one or more virtual cameras controlled by the first user.

7. The method of claim 1, wherein the one or more first representative values of the angles includes a mode value of the angles between the orientation vectors of the one or more content items and the view directions of the one or more virtual cameras in the virtual environment, and wherein the one or more first representative values of the on-screen real estates includes a mode value of the on-screen real estates of the one or more content items based on the distances between the one or more content items and the one or more virtual cameras controlled by the first user.

8. A system for screening users in virtual environments, the system comprising:
a hardware processor that is configured to:
determine one or more first representative values of one or more first metrics for a first user, wherein the one or more first metrics are associated with one or more content items presented within a virtual environment and wherein the one or more first metrics includes: (i) angles between orientation vectors of one or more content items and view directions of one or more virtual cameras in the virtual environment, wherein the one or more virtual cameras are controlled by the first user; (ii) on-screen real estates of the one or more content items based on distances between the one or more content items and the one or more virtual cameras controlled by the first user; (iii) view duration in which a content item of the one or more content items was at least partially presented for the first user on a rendered screen of the virtual environment during a predetermined amount of time; and (iv) a comparison between the view duration and a duration in which the one or more virtual cameras were controlled by the first user during the predetermined amount of time;
in response to determining the one or more first representative values of the one or more first metrics, compare the one or more first representative values to one or more corresponding reference values, wherein comparing the one or more first representative values to the one or more corresponding reference values comprises determining a fraud score based on the one or more first representative values and the one or more corresponding reference values;
in response to determining the fraud score, determine that the fraud score is within a first predetermined range of values; and
in response to determining that the fraud score is within the first predetermined range of values, determine that the first user in the virtual environment is a human user.

9. The system of claim 8, wherein the hardware processor is further configured to:
in response to determining that the first user is a human user, store an association between a first category indicating that the first user is a human user; and
store a number of views associated with the first user.

10. The system of claim 8, wherein the one or more corresponding reference values are based on second representative values of one or more second metrics, wherein the one or more second metrics include: (i) second angles between the orientation vectors of the one or more content items and second view directions of one or more second virtual cameras in the virtual environment, the one or more second virtual cameras controlled by a plurality of users; (ii) second on-screen real estates of the one or more content items based on distances between the one or more content items and the one or more second virtual cameras controlled by the plurality of users; (iii) a second view duration in which the content item of the one or more content items was at least partially presented for the plurality of users on the rendered screen of the virtual environment during a predetermined amount of time; and (iv) a second comparison between the second view duration and a second duration in which the one or more second virtual cameras were controlled by the plurality of users during the predetermined amount of time.

11. The system of claim 8, wherein the determining of the one or more first representative values of the one or more first metrics for the first user is performed at a first time, and wherein the hardware processor is further configured to:
determine one or more third representative values of the one or more first metrics for the first user at a second time;
in response to determining the one or more third representative values of the one or more first metrics, compare the one or more third representative values to one or more corresponding second reference values, wherein comparing the one or more third representative values to the one or more corresponding second reference values comprises determining a second fraud score based on the one or more third representative values and the one or more corresponding second reference values;
in response to determining the second fraud score, determine that the second fraud score is within a second predetermined range of values;
in response to determining that the second fraud score is within the second predetermined range of values, determine that the first user is a nonhuman user; and
in response to determining that the first user is the nonhuman user, inhibit the first user from accessing the virtual environment by removing one or more accounts associated with the first user.

12. The system of claim 8, wherein the one or more first representative values of the angles includes a mean value of the angles between the orientation vectors of the one or more content items and the view directions of the one or more virtual cameras in the virtual environment, and wherein the one or more first representative values of the on-screen real estates includes a mean value of the on-screen real estates of the one or more content items based on the distances between the one or more content items and the one or more virtual cameras controlled by the first user.

13. The system of claim 8, wherein the one or more first representative values of the angles includes a median value of the angles between the orientation vectors of the one or more content items and the view directions of the one or more virtual cameras in the virtual environment, and wherein the one or more first representative values of the on-screen real estates includes a median value of the on-screen real estates of the one or more content items based on the distances between the one or more content items and the one or more virtual cameras controlled by the first user.

14. The system of claim 8, wherein the one or more first representative values of the angles includes a mode value of the angles between the orientation vectors of the one or more content items and the view directions of the one or more virtual cameras in the virtual environment, and wherein the one or more first representative values of the on-screen real estates includes a mode value of the on-screen real estates of the one or more content items based on the distances between the one or more content items and the one or more virtual cameras controlled by the first user.

15. A non-transitory computer-readable medium containing computer executable instructions that, when executed by a processor, cause the processor to perform a method for screening users in virtual environments, the method comprising:
determining one or more first representative values of one or more first metrics for a first user, wherein the one or more first metrics are associated with one or more content items presented within a virtual environment and wherein the one or more first metrics includes: (i) angles between orientation vectors of one or more content items and view directions of one or more virtual cameras in the virtual environment, wherein the one or more virtual cameras are controlled by the first user; (ii) on-screen real estates of the one or more content items based on distances between the one or more content items and the one or more virtual cameras controlled by the first user; (iii) view duration in which a content item of the one or more content items was at least partially presented for the first user on a rendered screen of the virtual environment during a predetermined amount of time; and (iv) a comparison between the view duration and a duration in which the one or more virtual cameras were controlled by the first user during the predetermined amount of time;
in response to determining the one or more first representative values of the one or more first metrics, comparing the one or more first representative values to one or more corresponding reference values, wherein comparing the one or more first representative values to the one or more corresponding reference values comprises determining a fraud score based on the one or more first representative values and the one or more corresponding reference values;
in response to determining the fraud score, determining that the fraud score is within a first predetermined range of values; and
in response to determining that the fraud score is within the first predetermined range of values, determining that the first user in the virtual environment is a human user.

16. The non-transitory computer-readable medium of claim 15, wherein the method further comprises:
in response to determining that the first user is a human user, storing an association between a first category indicating that the first user is a human user; and
storing a number of views associated with the first user.

17. The non-transitory computer-readable medium of claim 15, wherein the one or more corresponding reference values are based on second representative values of one or more second metrics, wherein the one or more second metrics include: (i) second angles between the orientation vectors of the one or more content items and second view directions of one or more second virtual cameras in the virtual environment, the one or more second virtual cameras controlled by a plurality of users; (ii) second on-screen real estates of the one or more content items based on distances between the one or more content items and the one or more second virtual cameras controlled by the plurality of users; (iii) a second view duration in which the content item of the one or more content items was at least partially presented for the plurality of users on the rendered screen of the virtual environment during a predetermined amount of time; and (iv) a second comparison between the second view duration and a second duration in which the one or more second virtual cameras were controlled by the plurality of users during the predetermined amount of time.

18. The non-transitory computer-readable medium of claim 15, wherein the determining of the one or more first representative values of the one or more first metrics for the first user is performed at a first time, and wherein the method further comprises:
determining one or more third representative values of the one or more first metrics for the first user at a second time;
in response to determining the one or more third representative values of the one or more first metrics, comparing the one or more third representative values to one or more corresponding second reference values, wherein comparing the one or more third representative values to the one or more corresponding second reference values comprises determining a second fraud score based on the one or more third representative values and the one or more corresponding second reference values;
in response to determining the second fraud score, determining that the second fraud score is within a second predetermined range of values;
in response to determining that the second fraud score is within the second predetermined range of values, determining that the first user is a nonhuman user; and
in response to determining that the first user is the nonhuman user, inhibiting the first user from accessing the virtual environment by removing one or more accounts associated with the first user.

19. The non-transitory computer-readable medium of claim 15, wherein the one or more first representative values of the angles includes a mean value of the angles between the orientation vectors of the one or more content items and the view directions of the one or more virtual cameras in the virtual environment, and wherein the one or more first representative values of the on-screen real estates includes a mean value of the on-screen real estates of the one or more content items based on the distances between the one or more content items and the one or more virtual cameras controlled by the first user.

20. The non-transitory computer-readable medium of claim 15, wherein the one or more first representative values of the angles includes a median value of the angles between the orientation vectors of the one or more content items and the view directions of the one or more virtual cameras in the virtual environment, and wherein the one or more first representative values of the on-screen real estates includes a median value of the on-screen real estates of the one or more content items based on the distances between the one or more content items and the one or more virtual cameras controlled by the first user.

21. The non-transitory computer-readable medium of claim 15, wherein the one or more first representative values of the angles includes a mode value of the angles between the orientation vectors of the one or more content items and the view directions of the one or more virtual cameras in the virtual environment, and wherein the one or more first representative values of the on-screen real estates includes a mode value of the on-screen real estates of the one or more content items based on the distances between the one or more content items and the one or more virtual cameras controlled by the first user.
